(19) United States
(12) Patent Application Publication
(10) Pub. No.: US 2008/0027880 A1
(43) Pub. Date: Jan. 31, 2008

(54) Investment chart-based interactive trade simulation training and game system

(76) Inventor: Dan Yu, Herndon, VA (US)

Correspondence Address: LATIMER, MAYBERRY & MATTHEWS IP LAW, LLP, 13873 PARK CENTER ROAD, SUITE 122, HERNDON, VA, 20171, US

(21) Appl. No.: 11/482,033

(22) Filed: Jul. 7, 2006

(51) Int. Cl. G06Q 40/00

(52) U.S. Cl. 705/36 R

(57) ABSTRACT

An investment chart based interactive trade simulation and game system is provided. The system uses a computer or other computing device, real historical data, and a computer program to dynamically recreate the investment charts of any moment back to any date in the history, as long as the historical data exists. It interacts with players to dynamically recreate the real market environment in the history, and allows them to make investment decisions as though the market were today's market. The system can simulate any market, such as stock, bond, currency, and commodity markets, and any investment vehicle, such as options and futures.

### BACKGROUND OF THE INVENTION

1. Field of the Invention

The present invention relates to the field of simulations and game systems. More specifically, the present invention relates to a computer simulation and game system for simulating trading markets in the financial sector of the world economy. The computer programs of the invention find use in investment education, training, and entertainment for professional traders and the general population as well.

2. Description of Related Art

In today's investment world, investors and traders use two popular methods for helping make investment decisions. One method is termed “fundamental analysis”, whereas the other is termed “technical analysis”. Each has its merits and drawbacks, and certain professional investors prefer one over the other, while others prefer to use both methods to devise an investment strategy.

At a basic level, fundamental analysis is the attempt to estimate the value of a currency, a share, or an entire equity or bond market based on profitability, management or economic strength, or future prospects. Technical analysis, on other hand, attempts to use past stock price and volume information to predict future price movements. It also attempts to time the markets. Where fundamental analysis focuses on value, technical analysis concerns itself with price, volume of transactions, and individual/group psychology.

One of the many attractions of the technical analysis approach is that its methodology can be applied almost identically in any market anywhere. The approach works as well in the United States as in China as in Europe, and in developed or developing markets. The same techniques can be applied to currencies, commodities, bonds, interest rates, and equities.

Technical analysis, which is also sometimes referred to as market analysis, is the oldest method of financial analysis in the world. For a technical analyst, charts are considered one of the best tools to have at their disposal. For the purpose of analyzing investments and designing trading strategies, charts enable investors and analysts to plot investment prices, volumes, and other indicators in a graph, which is commonly referred to as an investment chart. As used herein, an investment chart includes a Line Chart, a Bar Chart, a Candle Bar Chart, and the like. Most people in the field find these investment charts very useful. In essence, technical analysis is all about constructing investment charts and analyzing them to draw conclusions about an investment: when to buy and when to sell. With the help of a computer, constructing investment charts is relatively easy now. The hard part still remains reading the charts effectively and making wise investments based on the charts.

However, things are not as simple as it might appear. It is not enough to know how to read the charts, spot the patterns indicated by the charts, or have a good trading strategy. Otherwise, there would be more millionaires in this world today. To have success in the investment world, investors and traders must also have good money management skills. They also must especially to know how to discipline themselves all the time. Indeed, many well-known investors have ultimately failed or faltered because of a lack of discipline, which ultimately typically results from the weaknesses of a human being's nature.

Traditionally, people who desired to become traders in any of the various markets open to trading learned their skill by studying under other more experienced traders and/or through trial and error. Today, in addition to the traditional method, people can gain some experience by studying history charts. Further, they might borrow or develop some good strategies by doing back-testing with the help of commercial software like Trade Station. But using these methods, it is hard for them to fully understand what discipline and good money management really means because they do not learn painful lessons from the actual market. It is hard for them really understand the advantages and the limits of different trading strategies.

With the advent of computer technology, there are now some services that provide people an account for virtual trading in the real market. Now, people no longer have to risk their hard-earned cash to learn painful lessons from the market. Instead, they learn it by virtual trading day by day, month by month, and year by year. The drawback of this approach is that it is slow: people have to spend years to learn from the market using these systems. When they feel confident and decide to do real trading, the market condition might have changed completely, say from bull to bear. The experiences learned and the strategies developed in the bull market will not work at all in the bear market.

Others have developed games to provide would-be traders an opportunity to experience the thrill and excitement of trading. However, these games are just that—games. While they provide some rudimentary approximations of real-life trading, they are not based on real-life data or other facts. Accordingly, their value in training and education is limited.

For example, U.S. Pat. No. 6,709,330 to Klein et al. discloses a stock simulation options trading game, which is, in essence, a game engine for simulating a real-world options trading environment. The game engine keeps track of game time and other game settings, and provides an options market simulator. The game includes random-event generator, which affects the price of companies available for trading in the game. Random events are not disclosed as having any real-world relationship to any particular real-world company, but are rather provided as a means for causing the value of companies generated by the game to rise and fall as the game progresses. The game runs in four week intervals, and the players are not able to stop the game within any of the individual four weeks.

In addition, others have developed investment tools that are disclosed as providing predictive value for purchase and sale of investments. For example, U.S. Pat. No. 6,907,404 to Li discloses an automated investment chart pattern search system. The system is disclosed as using historical charts and real-time data to automatically assist investors in deciding whether to buy or sell investments. The system is disclosed as having the ability to automatically analyze a large number of investments without input from the user. The system uses supplied templates to determine whether an investment should be sold or held, or additional shares purchased. The system removes the decision-making process, or at least a significant portion of the decision-making process, from the user, instead providing instructions as to whether to buy or sell a particular stock, bond, etc. In essence, it is a computer aided trading system.

Computer programs and systems are also known for training traders in the various markets. For example, U.S. Published Patent Application No. 2005/0233286 of Colaio et al. discloses systems and methods that enable students to participate in a simulated, electronic trading environment to educate them on the trading of financial products. The systems include data on financial products that have no intrinsic value, and are within a simulated market. The value is set within the system, and varies depending on the activities of the human participants using the system and based on pre-set rules intrinsic to the system. While the systems can function to train students on the activities involved in trading, the system does not provide a system that is based on real-world trading data, but rather evolves a simulated market as players make decisions.

To address the shortcomings of systems that rely on simulated markets, others have developed systems that rely on real-time, actual data from the stock market to provide more realistic training and entertainment. For example, U.S. Pat. No. 6,773,350 to Yoshimi et al. discloses a system and method for obtaining real-time data from a market and using that data to determine the current condition of a user's portfolio. The performance of the user can be compared to the performance of other users. Likewise, U.S. Published Patent Application No. 2004/0064395 of Mintz et al. discloses a system for simulating an electronic trading environment. The system uses real-time data to build a simulated market, which allows users to invest in the realistic simulated market without the risk of investing actual money. However, such systems suffer from the drawbacks mentioned above. In particular, they are limited in usefulness in training because they are limited to use in real-time. Thus, while they eliminate the risk of loss of money that is involved in traditional training programs (which require actual investments in actual markets), they still require substantial time to learn the skills needed to effectively trade in markets.

None of the simulation systems mentioned above provide any popular tools that are used by investors or traders in the real market trading. Rather, the simulation systems work for specific market or investment vehicles. They are not general and genuine simulation systems that can simulate any market and any investment vehicle. Further, they are not simple and yet real enough for ordinary people to use. Thus, there is still a need in the art for a system and method for training and entertainment relating to trading in financial markets. The system and method should preferably be based on factual data to represent a real-world situation and interact with users to allow them to make investment decisions, and also be capable of quickly covering long time spans to show the effects of various trades and trading strategies on the value of a portfolio.

### SUMMARY OF THE INVENTION

The present invention addresses needs in the art by providing a computer program, a method, and a system for training of traders in the various financial markets throughout the world, and for providing a game for entertainment of traders and non-traders alike. The program, method, and system use historical factual data on markets as a basis for training and game sessions. The program, method, and system permit users to select one or more markets of interest, optionally one or more individual assets (e.g., a single company stock, a mutual fund, a real estate sector, a precious metal, etc.), one or more investment vehicles of interest (e.g., stock, option, future, spread, etc.), and a particular investment strategy, and test or play that strategy over a given time period in the select market(s) to determine the effectiveness of the choices on actual real-world data from the selected market(s). Because the program, method, and system use factual historical data, users can replay the chosen market over the same historical time period using multiple investing strategies to optimize the strategy or learn the shortcomings and strengths of different strategies. Likewise, a particular investment strategy can be used in multiple, historically accurate time spans to determine the shortcomings and strengths of the strategy under different market conditions (e.g., bull market or bear market). Furthermore, the program, method, and system are capable of down-loading data from markets on a real-time basis, and thus allow users to test their strategies over a historical period and into one or more current markets. The program, method, and system are relatively fast, as compared to traditional training practices and as compared to computer systems based solely on real-time data from current markets. In addition, the program, method, and system are superior to training and game systems that uses simulated markets because the present program, method, and system show the effects of decisions in real-world markets.

In general, the present invention relates to a simulation and game system. More particularly, the present invention relates to a method and system that interacts with players to create a dynamic environment that is very close to real world trading. The players have the opportunity to gain valuable trading experience, develop practical trading strategies and money management skills, and learn to discipline themselves in a very short time. It can simulate any trading market where movement of the market can be represented by investment charts, such as, for example, stock, bond, currency, commodities, and real estate markets.

Broadly speaking, an investment chart-based interactive trade simulation training and game system is provided. The system uses computers or other computing devices, real historical data, and a computer program to dynamically recreate the investment charts of any moment back to any date in the history (as long as the historical data exists). It interacts with players (used interchangeably herein with “users”) to dynamically recreate the real market environment at one or more points in history, and allows them to make investment decisions as though the market were happening today. It allows players go through decades of any market history in a very short time, and at their own chosen pace. Players can play it again and again to quickly gain valuable experiences while others would have to spend years or even decades to achieve the same if in the real market or using systems based solely on real-time current data. The system helps people to develop trading strategies that are successful and/or fit their personal characters. For example, people can learn lessons from it and understand how important discipline and good money management are. The system provides a real-world trading environment and yet is simple enough so that people of any age, background, and profession can learn to use it quickly. Because, in embodiments, it is network (e.g., Internet) based, it allows people all over the world to share their experience or compete with each other in real time. It can integrate video games like fighting games into the investment simulation system seamlessly. It makes the already enjoyable system even more full of excitement and fun. Moreover, it can simulate any market such as stock, bond, currency, and commodity markets as long as its movement can be described by investment charts. It can simulate almost all of today's popular investment vehicles like stock, option, future, spread, or Contracts for Differences (CFD) and many sophisticated investment strategies like hedgy. Furthermore, it can simulate unlimited investments and markets simultaneously.

In a first aspect, the invention provides a computer program. The program simulates one or more financial markets using accurate, actual historical data and, optionally, real-time data from the market(s) of interest, and presents the data in one or more charts indicating one or more pieces of information about the market or individual components (e.g., company stock) of the market. The program further can track user's investments in markets or individual components of markets and indicate to the user the value of the investments. The computer program permits multiple users to invest in markets, and can track each user's activities and present those investments and the value of those investments to each user or multiple users to allow for an interactive game. The program may be in any programming language, and is, at its basic level, represented by computer code.

In a second aspect, the invention provides a method of simulating one or more financial markets using historical data from those markets. In general, the method comprises converting data from one or more markets into one or more charts representing the data in a graphical manner; and presenting the chart(s) to one or more users. The method typically also comprises permitting the user to select one or more markets for presentation of data and permitting the user to select one or more markets or one or more sub-markets (e.g., individual company stocks, precious metals, etc.) to invest in. Where users are permitted to invest, the method typically comprises permitting the user to invest a certain amount of money in each market or sub-market, and tracking the value of the investment over time.

In another aspect, the invention provides a storage medium comprising the computer program and/or method. The storage medium may be any medium that is suitable for storage of a computer program, including, but not limited to, a computer disk, such as a floppy disk, an optical computer disk, such as a compact disk (CD) or a digital virtual disk (DVD), a memory stick or flash drive, a hard disk, and random access memory (RAM). The storage medium is suitable for use in a computer or computer network, and may be removable and portable or may be an integral, non-portable part of a computer or computer network.

In another aspect, the invention provides a computer or computer network comprising the program or method of the invention. The computer may be any type of computer, including, but not limited to, a personal computer, a network server, a video game device, and a hand-held computing or communication device. The program may be present on the computer in a stable, long-term form, such as in the form of a program stored on a storage medium. Alternatively, the program may be present on the computer in an ephemeral form, such as in RAM. The computer or computer network may, of course, comprise only a portion of the program, for instance data files relevant to the user's actions (e.g., investments, performance, data relative only to particular investments, value of portfolio, etc.).

In yet a further aspect, the invention provides a system for simulating one or more markets or sub-markets. In general, the system comprises hardware and software, where the hardware is capable of running the software. In embodiments, the system comprises hardware, software, one or more databases, one or more network connections, and optionally other components. The system may comprise a single computer running the software, or multiple computers, each running a copy of the software or some or all sharing the software. The system thus may be a personal computer or a network of computers, such as the Internet or an intranet.

The invention thus provides a system, method, and program that use investment charts based on actual historical data, which have been used by many investors and traders to make investment decisions for decades and which have been proven useful over time. The system, method, and program use real historical data to recreate historical investment charts for the players, and can thus bring players back to any moment of any day in history and allow them to make investment decisions as though the historical date were the present date. The charts that players see are substantively no different than the charts that were seen by investors at a time in history. Use of historical data within a computer system makes it possible for players to experience days, years, or even decades of real market movement, and participate in one or more markets, in a relatively short time (e.g., minutes to hours), while receiving bona fide results that are based on actual historical performance of the market(s) or sub-market(s). This allows users to learn based on historical fact, not arbitrary simulation parameters or the effects of other users of the system, and provides a true-to-life learning experience and entertainment experience. In addition, the system is interactive, allowing players to participate at the player's own pace. Because the system and method is computerized, users may run the investment time period again and again to optimize investment strategies and learn discipline in trading.

It is further an aspect of the present invention to integrate video games, like fighting games, into this system seamlessly. Doing so will attract kids and those adults who think investment is hard to learn. Yet while playing the games, those people will learn investment strategies and techniques.

In yet a further aspect, the invention provides a method of doing business using a computer or computer system. The method comprises providing a computer program according to the invention on a computer connected to the Internet, and charging a fee for use of the program. The fee may be charged for use of the program over the Internet (i.e., for access to a website running the program). Alternatively, the fee may be charged for downloading of the computer program from a website on the Internet. Yet again, the fee may be charged for purchase of a portable storage medium comprising the computer program (e.g., a CD to be shipped to the purchaser).

### BRIEF DESCRIPTION OF THE DRAWINGS

The accompanying drawings, which are incorporated in and constitute a part of this specification, illustrate several embodiments of the invention and together with the written description, serve to explain certain principles of the invention. Other principles and details of the invention may be found in the written description or be evident from the drawings, written description, claims, and general knowledge held by those of skill in the art.

FIG. 1 is a diagram showing the main menu of the trade simulation and game system of one embodiment of the present invention. Included is a sub-menu for the simulation.

FIG. 2 is a diagram illustrating the getting start screen of the simulation from FIG. 1.

FIG. 3 is a screen shot showing the first screen of a normal single stock simulation according to an embodiment of the invention.

FIG. 4 is a diagram illustrating the architecture of the trade simulation and game system according to one embodiment of the present invention.

FIG. 5 is a player simulation screen shot just after the market is open to demonstrate how to open an order in one embodiment of the program and system.

FIG. 6 is a player simulation screen shot when the market is about to be closed to demonstrate how to sell a position in one embodiment of the program and system.

FIG. 7 is a screen shot illustrating that the system of present invention can simulate a situation of stop loss.

FIG. 8 is a screen shot of single stock simulation with an intraday chart.

FIG. 9 demonstrates the ability of the system of embodiments of the present invention to simulate many sophisticated investment strategies, including hedge.

FIG. 10 demonstrates the ability of the system of embodiments of the present invention to handle incomplete intraday data.

FIG. 11 demonstrates the ability of the system of embodiments of the present invention to synchronously simulate multi-markets at the same time.

FIG. 12 demonstrates the capability of the system of embodiments of the present invention to handle complicated simulation situations.

FIG. 13 demonstrates the ability of the system of embodiments of the present invention to synchronously simulate unlimited markets at the same time.

FIG. 14 demonstrates how to set warnings, conditions, orders, and triggers in the system of embodiments of the present invention.

FIG. 15 is a screen shot of simulation historical files selection form of an embodiment of the invention.

FIG. 16 is a screen shot on reviewing simulation records of an embodiment of the invention.

FIG. 17 is a screen shot demonstrating that the players all over the world can chat with each other through the system of embodiments of the present invention.

FIG. 18 is a screen shot of the Internet competition game of embodiments of the present invention.

FIG. 19 is a screen shot of the simulation Setting form according to embodiments of the invention.

FIG. 20 is a screen shot of the setting screen of multi-stocks simulation according to embodiments of the invention.

FIG. 21 demonstrates the way that video games, such as battle games, can be seamlessly integrated into the trade simulation and game system of embodiments of the present invention.

FIG. 22 is a flow diagram illustrating the working mechanism of multi-stocks simulation with multi-screens, intraday charts, and news broadcasting according to embodiments of the invention.

FIG. 23 is a diagram illustrating the working mechanism of embodiments of the system of the present invention, which simplify and unify the trading processes of all trading vehicles.

FIG. 24 is a screen shot demonstrating stock quote and option chain from the real market according to embodiments of the invention.

FIG. 25 is a flow chart illustrating how embodiments of the system of the present invention select an option quote.

### DETAILED DESCRIPTION OF VARIOUS EMBODIMENTS OF THE INVENTION

Reference will now be made in detail to various exemplary embodiments of the invention, examples of many of which are illustrated in the accompanying drawings. It is to be understood that reference to these embodiments is not a limitation on the scope of the invention. Rather, the following detailed description is provided to better explain various features of the invention.

In a first aspect, the invention provides a computer program. In essence, the computer program is computer software comprising instructions for the training and educational tool of the invention. The program may be in any computer language, optimized to run on any platform (e.g., Windows, Mac, Linux, UNIX). At its core, the computer program is computer-readable code, which may be compiled using any number of suitable and commercially or otherwise publicly available compilers. While a single source code may be particularly advantageous in implementing the computer program of the invention, the invention is not limited to any particular code, algorithm, or series of linear steps. Rather, any computer program that achieves the actions and functions of one or more of the various embodiments of the present invention are encompassed by the invention. Those of skill in the art are well aware of the numerous different ways of achieving the functions described herein, and any such way is encompassed by the present computer program. As a general matter, the computer program of the method implements the method of the invention on a computer or a system comprising a computer.

The computer program of the invention, which in practice is executed on one or more computers, simulates one or more financial markets, or portions thereof, using accurate, actual historical data and, optionally, real-time data from the market(s) of interest. In a typical embodiment, the program uses historical data to generate one or more charts. It also presents to one or more users the data in the form of these one or more charts. The charts may provide any type of historically relevant data (e.g., opening stock price for a particular stock, closing average price for an entire market, price of a particular currency at a given time of a given day, etc.), and may provide data on a single parameter (e.g., a single company's stock) per chart or on multiple parameters per chart. In general, the computer program provides one or more charts indicating one or more pieces of information about one or more markets or one or more individual components (also referred to herein as a portion of a market or a sub-market) of the market. The computer program is exceptionally robust and may provide a plethora of data on demand in the form of charts for ease of reference and understanding by the user.

As mentioned above, the financial markets encompassed by the present invention include all markets for which trading is known. The markets may be national (from any country) or international. The markets may relate to money, per se, such as currency markets, or may relate to financial institutions (e.g., insurance carriers, mortgage brokers), corporations (e.g., stocks for individual companies), and even individual products or services (e.g., precious metals). Likewise, the markets may relate to government issues other than currency (e.g., federal, state, or local bonds). In addition, the markets may relate to imaginary or intangible concepts, such as futures, options, and the like. In sum, any market for which there is trading and data available is encompassed by the present invention.

The program of the invention obtains historical, and where appropriate real-time up-to-date, data on various parameters of one or more markets. The data is typically publicly available, although in embodiments, it must be collated from two or more sources. Computer programs for accessing and organizing the available data may be used from publicly available sources or developed specifically by a programmer. In either case, such programs may be implemented to obtain the desired data without unusual or excessive work. The program of the invention stores and organizes the data for presentation to users in one or more useful forms, such as in the form of investment charts. In embodiments, the data is obtained for multiple time points per day per market, such as minute-by-minute or hour-by-hour during the course of the time that the market is open. In other embodiments, the time points are longer, such as day-by-day.

The program is capable of presenting the data in any time format selected by the user, limited only by the frequency of time points available from the historical records. For example, where historical data is available on an hour-by-hour basis, the program may present the data on an hour-by-hour basis, a half-daily format, an opening-and-closing quote format, a daily format (e.g., closing price), or a weekly format (e.g., closing price at the end of the week, average price for the week).

The program is also capable of presenting any amount of the data selected by the user. Thus, while the program may comprise multiple data points relating to multiple aspects of a particular market or sub-market, the computer program can present to the user only a sub-set of the data. For example, even though an hour-by-hour record of a particular company's stock price is available, the program can present to the user only the opening and closing price. The program is capable of presenting any number of combinations of data points to the user, and the data points to be presented may be altered during use of the program at the discretion of the user. Thus, for example, a user may initially elect to see only the opening daily price of gold, but later in the same session elect to see the hour-by-hour variation in price. The program is thus highly adaptable and user friendly.

The program may provide updated information to the user, and preferably stores the updated information in one or more files for later use. Thus, while the program may be initially provided on a CD or other portable storage medium, data on markets can be updated after sale of the storage medium to a purchaser, allowing the purchaser to access market data that only became available after the program was stored on the medium. In embodiments, the computer program is capable of accessing and downloading the updated data, for example, by way of an Internet connection supplied by the user. In a similar fashion, the computer program may supply, in addition to the historical data, real-time or near real-time data for use in the program, system, and method.

In addition to obtaining, storing, and presenting historical, and optionally real-time, data on one or more markets or portions thereof, the computer program of the invention presents users with multiple options for investing. One or more menus, such as drop-down menus, are provided to the user, each with a set of parameters that may be selected, and which are relevant to investment in a particular market or sub-market. Typically, the program prompts a user to enter a screen name for a session, which may be stored and re-used in another session. In addition, a user is typically provided the choice of which market or sub-market is of interest for a particular session. Likewise, the user may select the amount of money initially available for investment, the amount of money to invest per action, and the length of time for the simulation to run (e.g., to simulate one year, five years, ten years, fifty years, etc.). Any number of choices may be supplied, the selection of the number and type of choices being a non-critical selection left to the desires of the practitioner of the present invention for each embodiment created. Of course, default settings are supplied, and a user may elect to use the default setting for a particular choice option, which may be coded to be the same or vary from session to session.

Based on parameters selected by the user or generated as or taken from defaults by the program, the program simulates one or more markets and/or sub-markets, and presents data on those markets and/or sub-markets to the user, primarily by way of investment charts. The data points depicted in the investment charts may be supplemented with written or auditory information, which may provide additional information of interest to the user, or may be instructional in nature. Examples of such information include, but are not limited to, warnings regarding low funds available or unavailable funds for investment, warnings regarding closure of markets for holidays or weekends, and the like. In sum, any information that is relevant to the market or the user's portfolio may be provided.

The investment charts provided by the program are continuously updated, based on the speed at which the simulation has been set to run and the number of data points available. It is to be noted that, as discussed above, multiple investment charts may be run simultaneously. Where the number of charts being run exceeds a number that can reasonably be presented by a computer screen, the program will generate multiple screens or pages of charts and permit the user to scroll or otherwise move from one screen or page to another.

As the program provides the user with investment charts of data, the user is provided the option to alter (e.g., buy, sell) his investments. Changes to a user's investment portfolio may be made at any time a market of interest is open, subject to availability of funds. The program keeps track of the user's investment portfolio continuously, and can provide the user with a running total of funds invested, funds available, and, if applicable, funds earmarked for future investment or liquidation.

Thus, the program, and any system comprising the program, can track one or more users' investments in markets or sub-markets and indicate to the users the value of the investments. The computer program, and any system comprising the program, permits multiple users to invest in markets, and can track each user's activities and present those investments and the value of those investments to each user or multiple users to allow for an interactive game.

In preferred embodiments, the program, and any system comprising the program, automatically and randomly selects a start and end date (or time) for each session, and the actual dates from which the data was obtained are not divulged to the user. In this way, it is not possible for the user to know how the market will play out over the time course of the session (e.g., cannot use personal knowledge of a particular period in history to influence his investments). Of course, the program (and system) is also capable of allowing users to select dates (and times) for each session, if desired.

The program is capable of retaining the investment portfolio performance at multiple time-points during a session, for later analysis by the user. This is particularly advantageous when the program is used as a training tool because it allows the user to identify weaknesses in his strategy or in his actions at various times during a session. In view of this feature, it should be evident that the program is capable of long-term storage of various sessions, for later review and/or for comparison to other sessions.

In a general sense, the program, and any system comprising the program, can be a training tool for professionals in the investment industry. It likewise may be an educational tool for students learning to become professionals in the investment industry or for general knowledge. In addition, the program (and system) can be a game for entertainment of the general population. It may be provided as a stand-alone computer program, for example for purchase from a computer software store, as a stand-alone computer program for download from the Internet, or as a network (e.g., world-wide-web)-based computer program that may be accessed by connection to one or more servers within the network. Where configured or used as a training tool, users may learn from repetitive use of the program (and system) to improve their investing skills, strategies, and discipline. Where configured or used as a game, users may improve their score by improving their investing skills, strategies, and discipline, may improve their performance as compared to other players, or may simply use the program (and system) as a diversion from daily chores and routines. As the program, and any system comprising it, is capable of permitting use, and particularly interactive use, by multiple users at one time, competitive gaming is provided. Preferred embodiments include a computer program for interactive investment trade simulation, where the program comprises computer-readable instructions for: obtaining real historical data and information from or about one or more markets in which trading can or did occur; simulating the market(s) using the historical data and other information, wherein the markets are simulated in a compressed manner with respect to time; and displaying the data and information to a user in a form comprising at least one chart. In embodiments, the computer program (and system) further comprises instructions for, or otherwise allows for: allowing a user to invest and withdraw funds from one or more of the simulated markets. In embodiments, compression of time causes the simulated market to run at a faster speed than real time, for example such that 1 hour of historical market time occurs per one second of real time. In particular embodiments, the computer program (and system) comprises instructions for or otherwise allows for one or more of the following: providing a Trade & Game Interface for interfacing of a user and a computer; providing a Simulation & Game Controller for directing and coordinating sub-systems to work together to create one or more different markets and investments in the Trade & Game Interface; providing a Dynamic Charts Generator for creating dynamic daily charts and intraday charts; providing a Trade Manager using a General Trading Method to create a simplified and unified interface for all investments and investment vehicles; providing a Data Loader for loading historical data and simulation parameters, mode, and layout associated with a predefined simulation; providing a Simulation Setting Interface for predefining a simulation and setting up its parameters, mode, and layouts; providing a Portfolio Manager for creating a portfolio interface and dynamically updating the portfolio; providing an Account Manager for creating an account interface and allowing a player to manage his account; providing a P2P Module for communicating with other players via at least one server of a network; providing a Recording & Playback System for automatically recording a player's trade operations and allowing him play it back for study; providing a Coach System for education assistance on investment technical analysis; providing a Game Engine for generating video games for integration into a market simulator; and providing an External Game Interface to allow external games to be integrated into a system comprising the program.

In accordance with the totality of the discussion of the invention herein, the invention provides a computer program with means for performing some or all of the steps mentioned above and below. As discussed above, the means may be any suitable computer code, algorithm, or series of steps that provide the features of the present computer program. The means need not be implemented in any particular order as long as a suitable user session is provided. Furthermore, as should be evident, the computer program and all the means embodied by it need not be provided as a single program or set of files. Instead, the program, as a whole, may be provided in multiple parts on different storage media or computers. Thus, for example, executable files may be stored on one or more computers within a network, while historical data files are stored on the same or another computer on the network, while personal user files relating to personal user sessions may be stored on the same or yet another computer (e.g., the individual user's computer). Any permutation of combinations of storage places are envisioned by the present invention, as long as a functional end product is achieved.

In another broad aspect, the invention provides a method of simulating one or more financial markets or sub-markets using historical data from those markets or sub-markets. In accordance with the discussion above relating to computer programs and systems comprising them, the financial market(s) may be any market(s) in which trading is performed and historical data is available. In embodiments, the historical data is supplemented with real-time data. As used herein, historical data encompasses updated information, which is not real-time data, but which became available only after a computer program embodying the method was produced. In embodiments, the method is provided in the form of software, such as a computer program.

In general, the method comprises converting data from one or more markets or sub-markets into one or more investment charts representing the data in a graphical manner; and presenting the chart(s) to one or more users. The method typically also comprises permitting the user to select one or more markets for presentation of data and permitting the user to select one or more markets or one or more sub-markets (e.g., individual company stocks, precious metals, etc.) to invest in. Where users are permitted to invest, the method typically comprises permitting the user to invest a certain amount of money in each market or sub-market, and tracking the value of the investment over time. In preferred embodiments, the method is implemented by way of a computer program, as discussed above.

Thus, in embodiments, the method is an investment chart-based interactive trade simulation training and game method in which the method comprises the steps of: using at least one computer; using at least one database accessible by the computer, wherein the database comprises real historical information for a plurality of investments, and wherein the database optionally comprises simulation settings for the investments; executing software on the computer that generates a simulation interface displayed on one or more screens, wherein the simulation interface comprises one or more investment charts on one or more screens using the real historical data from the database; and providing one or more players or users the ability to interact with the simulation interface and execute investment decisions within one or more simulated markets, wherein the markets are simulated based on the historical data. Typically, the method is implemented using a personal computer, a video game device, a network server, a hand-held computing or communication device, or a combination of two or more of these. At times, the method comprises providing only one key investment symbol representing settings of a simulation predefined in a Simulation Setting Method (discussed below); wherein the key investment symbol may be selected by a player. Typically, the Simulation Setting Method comprises the steps of: providing a main symbol for the simulation to be defined; providing a simulation mode for the simulation to be defined; optionally providing a definition method of multi-screens for screen definitions if multi-investments simulation is involved; providing settings for different investment vehicles if multi-investment vehicles are involved in the simulation; and providing parameters for trading. In some embodiments, the definition method of multi-screens comprises the steps of: providing a screen ID number for each screen to be defined; providing a screen name for each screen to be defined; providing investment symbols and their layout on the screen for each screen to be defined; and optionally repeating the above steps to define more screens.

In embodiments, the method comprises: providing a start date for the simulation, which may be selected by a player, wherein the start date is: 1) randomly selected by the simulation and game system; 2) specified by the player; 3) specified in one or more files selected by the player; or 4) predefined in the simulation and game system. In embodiments, the method comprises: providing a separate trading account and a saving account for the player, wherein funds may be transferred between the two accounts; providing a charting method that optionally hides prices and dates on the investment chart(s) from the player during the simulation; and/or providing a Compressed Time Simulation Method, which allows for the simulation of investment(s) been conducted, but in a compressed manner with respect to time. Where a Compressed Time Simulation Method is provided, the Compressed Time Simulation Method can cause the simulated investment market to run at X minutes of historical market time per one second of real time, where X could be any number range from 1 (e.g. 1 minute) to 1440 (e.g., 1440 minutes) or higher.

In some embodiments, the method comprises: providing a General Trading Method of Investments and a General Trading Method of Investment Vehicles, which allow a player to trade any investment through any investment vehicle in a unified and simplified manner. The General Trading Method of Investment Vehicles can comprise the steps of: optionally choosing a trading vehicle by a player; choosing buy or sell of the selected trading vehicle for a trade by a player and further choosing a position to sell if sell is chosen and the player has more than one position; optionally deciding a money amount used to buy or a money amount reclaimed for sell by the player; providing a Trade Engine to select an appropriate specific trade engine to handle the specific trading details of the selected trading vehicle and find out the Initial_Value and Initial_Unit_Price of a position if it is a buy, or the Money_Reclaim and New_Initial_Value if it is a sell; optionally executing a buy or sell choice or confirming an order by a player; wherein the method steps may be applied to any investment vehicle. Of course, one or more of the optional steps, including all of them, may be performed. The General Trading Method of Investment Vehicles could be applied to a new investment vehicle that might be created in the future by creating a new trade engine for the new investment vehicle and plug it to Trade Engine of the simulation and game system. The amount to buy or amount reclaim for sell can be expressed in any way, such as an amount of money, a percentage of money available, or a percent of an available amount of a position. The General Trading Method of Investments may comprise the steps of: providing a current unit price of an investment; providing an initial unit price of an investment; providing an initial value of a position; providing the current value, but not providing the quantity, of a position, wherein the current value of the position is calculated by the following formula: Current_Value=Current_Unit_Price*Initial_Value/Initial_Unit_Price; permitting a player to buy or sell a position based on ratio or all or a portion of the current value; optionally updating the initial value of the position; updating the current value, but not providing the quantity, of the position; and optionally repeating these steps.

The various values may be calculated using any suitable formula. For example, the initial value may be updated using the following formula when a portion of the position is sold: New_Initial_Value=(1−Sell_Ratio)*Initial_Value; and Sell_Ratio=Money_Reclaim/Current_Value. Likewise, if the player sells the position, the money reclaimed from the sale is calculated using the following formula: Money_Reclaim=Sell_Ratio*Current_Value.

The method may be predicated on one or more assumptions. For example, the method may assume infinite liquidity in a market; and/or set the last price of the historical data of an investment as both the bid price and ask price. Furthermore, the method may comprise yet additional optional steps. For example, the method may comprise providing a Visualized Setting Method for a player to set orders, warnings, conditions, and triggers directly on the investment charts. The Visualized Setting Method may comprise the steps of: providing graphic cues on the investment chart; moving the graphic cues to a appropriate price level on the investment chart by a player to set price desired; and allowing the player to set warnings, open orders, set conditions, and set triggers after a desired price has been set.

The method may likewise further comprise: providing a Auto-recoding and Playback Method to automatically record the player's trade operations during the simulation. The Auto-recoding and Playback Method may comprises the steps of: allowing a player to write down the reasons for buying or selling a position that will be recorded by the system; optionally providing a investment chart to help the player to better review the trading records; providing a table to display the recorded trading records; connecting a record in the table to a bar of the investment chart by the trading date; wherein, if a record in the table is clicked, the bar represent the day which the trade happened will be automatically imported into the investment chart, and a dashed line indicating the price level will appear; and automatically recording the trading information of the following: trading date showing the date when a simulated trade happened; trade action, which is either buy or sell; position name, which is the name of a position; trade price, which is the price for buying or selling a position of a simulated trade; trade ratio, which is the ratio of money used to money available or ratio of position sold to positions available; and money lost with time gives the player an idea what time worth money means in option and future trading.

The method may further comprise: providing an Unlimited Investments Simulation Method to simulate multi-investments at the same time. The Unlimited Investments Simulation Method may comprise the steps of: dividing and grouping multi-investments into one or more computer screens, wherein each screen can display a limited number investment charts, but the number of screens is unlimited; presenting one or more screens, each of which hold at least one investment chart for each investment being simulated; providing a method for quickly switching between screens; and providing a search system to locate a screen or the screen held an investment symbol been searched and quickly display the searched screen. In addition or alternatively, the method may comprise: optionally unifying historical data for all investments by making historical data of all investments have the same trading days each year. A dummy day can be added to the historical data of an investment if any day is missing. The close price of the previous day can be used as the price of the open, close, high, and low of the dummy day. In addition or alternatively, the method may comprise providing a method to handle one or more missing days in the historical data by adding a line on the daily investment chart next to the bar represent previous day to indicate the missed day during the simulation. Likewise, the method may additionally or alternatively comprise: providing a Globalize Timing Method to time the simulation order of different investments if global market investment simulation is involved; and/or providing a synchronized simulation for all investments being simulated at any moment. The Globalize Timing Method comprises: dividing 24/5 continues markets, like currency markets, into discontinues markets; using 5 pm EST of the United States of America as the close time of a current trading session (day) and the open time of the next trading session (day). Markets all over the world will be simulated in the order based on that start time; using the market price at 5 pm EST of the United States of America as the close price of the current trading session (day) and the open price of the next trading session (day).

The method may, in embodiments, further comprise: providing a Missing Data Handling Method to smoothly handle many complicated situations resulting from missing data. It also may additionally or alternatively comprise: a single investment simulation with daily investment chart method that uses limited historical data of a investment to simulate the market of that investment, wherein the limited historical data is a set of daily historical data and the daily historical data comprises the price of the open, close, high, low, and volume of one trading day.

The method may be an investment chart based interactive trade simulation training and game method, wherein the simulation and game method comprises the steps of: using at least one computer, where a computer is a personal computer, or a video game device, or a network server, or a hand-held computing or communication device; using at least one database accessible by the computer, wherein the database comprises real historical information for a plurality of investments and wherein the database optionally comprises simulation settings for the investments; executing software on the computer that generates a simulation interface displayed on one or more screens, and wherein the simulation interface comprises one or more investment charts using the real historical data from the database; and providing one or more players or users the ability to interact with the simulation interface and execute investment decisions within one or more simulated markets, wherein the markets are simulated based on the historical data; optionally providing an internet connection that enable the player to access historical information from servers and communicate with other people all over the world; selecting an investment symbol by a user (an investment symbol being any symbol, such as a main symbol, which is associated with a simulation settings predefined in the Simulation Setting Method); selecting a start date by a user (a start date being a date that is used to decide the start date of a simulation; the date can be selected as the start date is also constrained by the availability of historical data of selected main symbol); providing a separated trading account and a saving account (the trading account is for trading only and the saving account is for saving only (funds in this account can't be used for trading) and funds are allowed to be transferred between these two accounts); providing a charting method that optionally hides prices and dates on the investment chart(s) from users during the simulation based on the user's selection; providing a Compressed Time Simulation Method allowing the simulation of the investment(s) being conducted in a compressed manner with respect to time; providing a General Trading Method of Investments and a General Trading Method of Investment Vehicles allowing a user to trade any investment through any investment vehicle in a unified and simplified manner; providing a Visualized Setting Method for a user to set orders, warnings, conditions and triggers on the investment charts directly; providing a Auto-recoding and Playback Method to automatically record the user's trade operations during the simulation; and providing a single investment simulation with daily investment chart method that uses limited historical data of a investment to simulate the market of that investment (the limited historical data is a set of daily historical data; the daily historical data comprises the price of open, close, high, low, and volume of a trading day).

The method may be a simulation and game method as described above, wherein the method further comprises a single investment simulation with daily investment chart method comprising the steps of: allowing a user to see a daily investment chart displaying the moment when the simulated investment market is opening and allowing him to place orders, set warnings, set conditions, and set triggers at the open of a trading day of the simulated investment market by using the Visualized Setting Method; allowing a user to see a daily investment chart displaying the moment when the simulated investment market is opening and allowing him to execute buys or sells at the open price of the trading day immediately; allowing a user to see a daily investment chart displaying the moment when the simulated investment market is closing and allowing him to execute buys or sells at the close price of a trading day immediately; allowing a user to see a daily investment chart displaying the moment when a stop loss threshold of any position held by the user is reached during a simulation day and allowing him to execute buys or sells at the stop loss price immediately; allowing a user to see a daily investment chart displaying the moment when a preset warning price is found reached during a simulation trading day and allowing him to execute buys or sells at that warning price immediately; allowing a user to select an investment vehicle at the points mentioned above; allowing a user to select buy or sell after an investment vehicle is selected; allowing a user choose a position to sell from the portfolio if sell is selected; allowing a user to select the amount of money to use for buy or amount of money to reclaim for sell; allowing a user to execute the buy or sell or to confirm an order; allowing a user to transfer funds between trading account and saving account at any time; allowing a user to start the next trading day (this step can be repeated to move the simulation forward until its end); and optionally repeating some or all of the steps above.

The method may be an investment chart based interactive trade simulation training and game method comprising the steps of: using at least one computer, where a computer is a personal computer, or a video game device, or a network server, or a hand-held computing or communication device; using at least one database accessible by the computer, wherein the database comprises real historical information for a plurality of investments, and wherein the database optionally comprises simulation settings for the investments; executing software on the computer that generates a simulation interface displayed on one or more screens, and wherein the simulation interface comprises one or more investment charts using the real historical data from the database; and providing one or more players or users the ability to interact with the simulation interface and execute investment decisions within one or more simulated markets, wherein the markets are simulated based on the historical data; optionally providing an internet connection that enables the player to access historical information from servers and communicate with other people all over the world; selecting an investment symbol by a user (an investment symbol may be a main symbol, which is associated with a simulation settings predefined in the Simulation Setting Method); selecting a start date by a user (a start date can be used to decide the start date of a simulation; the date that can be selected as the start date is also constrained by the availability of historical data of selected main symbol); providing a separated trading account and a saving account (the trading account is for trading only and the saving account is for saving only (funds in this account cannot be used for trading) and funds are allowed to be transferred between these two accounts); providing a charting method optionally hides prices and dates on the investment chart(s) from the user during the simulation based on the user's selection; providing a Compressed Time Simulation Method allowing the simulation of the investment(s) being conducted in a compressed manner with respect to time; providing a General Trading Method of Investments and a General Trading Method of Investment Vehicles allowing a user to trade any investment through any investment vehicle in a unified and simplified manner; providing a Visualized Setting Method for a user to set orders, warnings, conditions and triggers on the investment charts directly; providing a Auto-recoding and Playback Method to automatically record the user's trade operations during the simulation; providing a single investment simulation with daily investment chart and intraday investment chart method that uses detailed historical data of a investment to simulate that investment market (the detailed historical data is a set of daily historical data and a set of detailed intraday data; the daily historical data comprises the price of open, close, high, low, and volume of a day; the detailed intraday data comprises price, volume, news and their corresponding time of the trading day minute by minute in great detail).

The method may be a simulation and game method as described above, further comprising a single investment simulation with daily investment chart and intraday investment chart method comprising steps of: allowing a user to place orders, set warnings, set conditions, and set triggers at any moment during a simulation trading day on the simulated investment by using the Visualized Setting Method; allowing a user to execute buys and sells at any moment of a simulation trading day on the simulated investment at the price of that moment; allowing a user to see a daily investment chart displaying any moment of the simulated investment market during a simulation day; allowing a user to see a intraday investment chart displaying any moment of the simulated investment market during a simulation day (the intraday investment chart is automatically advancing from the open of the investment market to its end); allowing a user to see a multi-day intraday chart; allowing a user to adjust the advancing speed of the intraday investment chart at any time; allowing a user to pause and resume the advance of the intraday investment chart at any time; automatically pausing the advance of the intraday investment chart if buy or sell selected from the choosing investment vehicle to give a user an opportunity to finish the buy or sell operation; synchronizing the movement of daily investment chart with the movement of intraday investment chart all the time during the simulation; allowing a user to transfer finds between trading account and saving account at any time; allowing a user to start the next simulation trading day (this step can be repeated to move forward the simulation until its end); allowing a user to select an investment vehicle at the points mentioned above; allowing a user to select buy or sell after an investment vehicle is selected; allowing a user choose a position to sell from the portfolio area if sell is selected; allowing a user to select the amount of money to use for a buy or amount of money to reclaim for sell; allowing a user to execute the buy or sell or to confirm an order; and optionally repeating some or all of the steps above.

The method may be an investment chart based interactive trade simulation training and game method comprising the steps of: using at least one computer, where a computer is a personal computer, or a video game device, or a network server, or a hand-held computing or communication device; using at least one database accessible by the computer, wherein the database comprises real historical information for a plurality of investments, and wherein the database optionally comprises simulation settings for the investments; executing software on the computer that generates a simulation interface displayed on one or more screens, and wherein the simulation interface comprises one or more investment charts using the real historical data from the database; and providing one or more players or users the ability to interact with the simulation interface and execute investment decisions within one or more simulated markets, wherein the markets are simulated based on the historical data; optionally providing an internet connection that enables the player to access historical information from servers and communicate with other people all over the world; selecting an investment symbol by a user; selecting a start date by a user; providing a separated trading account and a saving account; providing a charting method optionally hides prices and dates on the investment chart(s) from user during the simulation based on the user's selection; providing a Compressed Time Simulation Method allowing the simulation of the investment(s) been conducted in a compressed manner with respect to time; providing a General Trading Method of Investments and a General Trading Method of Investment Vehicles allowing a user to trade any investment through any investment vehicle in a unified and simplified manner; providing a Visualized Setting Method for a user to set orders, warnings, conditions and triggers on the investment charts directly; providing a Auto-recoding and Playback Method to automatically record the user's trade operations during the simulation; and providing a multi-investments simulation with daily investment chart method that uses limited historical data of the multi-investments to simulate those investment markets (the limited historical data is a set of daily historical data; the daily historical data comprises the price of open, close, high, low, and volume of a trading day).

The method may be a simulation and game as described above, further comprising a multi-investments simulation with daily investment chart method comprising the steps of: allowing a user to see multiple daily investment charts on a screen displaying the moment when the simulated investment markets are opening and allowing him to place orders, set warnings, set conditions, and set triggers at the open of a day of the simulated investment markets on those daily investment charts by using the Visualized Setting Method; allowing a user to see multiple daily investment charts on a screen displaying the moment when the simulated investment markets are opening and allowing him to execute buys or sells at the open prices of those investments of a day immediately; allowing a user to see multiple daily investment charts on a screen displaying the moment when the simulated investment markets are closing and allowing him to execute buys or sells at the close prices of those investments of a day immediately; allowing a user to see multiple daily investment charts on a screen displaying the moment when a stop loss threshold of any position held by the user is reached during a simulation day and allowing him to execute buys or sells at the stop loss price immediately; allowing a user to see multiple daily investment charts on a screen displaying the moment when a preset warning price is found reached during a simulation day and allowing him to execute buys or sells at that warning price immediately; allowing a user to select an investment vehicle at the any point mentioned above; allowing a user to select buy or sell after an investment vehicle is selected; allowing a user choose a position to sell from the portfolio if sell is selected; allowing a user to select the amount of money to use for a buy or amount of money to reclaim for sell; allowing a user to execute the buy or sell or to confirm an order; allowing a user to switch to other screens and switch back if more than one screen is defined for the simulation; allowing a user to quickly find a screen and switch to the screen found; allowing a user to transfer funds between trading account and saving account at any time; allowing a user to start the next trading day (this step can be repeated until the end of the simulation); and optionally repeating some or all of the steps above).

The method may be an investment chart based interactive trade simulation training and game method comprising the steps of: using at least one computer, where a computer is a personal computer, or a video game device, or a network server, or a hand-held computing or communication device; using at least one database accessible by the computer, wherein the database comprises real historical information for a plurality of investments, and wherein the database optionally comprises simulation settings for the investments; executing software on the computer that generates a simulation interface displayed on one or more screens, and wherein the simulation interface comprises one or more investment charts using the real historical data from the database; and providing one or more players or users the ability to interact with the simulation interface and execute investment decisions within one or more simulated markets, wherein the markets are simulated based on the historical data; optionally providing an internet connection that enables the player to access historical information from servers and communicate with other people all over the world; selecting an investment symbol by a user; selecting a start date by a user; providing a separated trading account and a saving account; providing a charting method optionally hides prices and dates on the investment chart(s) from user during the simulation based on the user's selection; providing a Compressed Time Simulation Method allowing the simulation of the investment(s) being conducted in a compressed manner with respect to time; providing a General Trading Method of Investments and a General Trading Method of Investment Vehicles allowing a user to trade any investment through any investment vehicle in a unified and simplified manner; providing a Visualized Setting Method for a user to set orders, warnings, conditions and triggers on the investment charts directly; providing a Auto-recoding and Playback Method to automatically record the user's trade operations during the simulation; and providing a multi-investments simulation with daily investment chart and intraday investment chart method that uses detailed multi-investments historical data to simulate those investment markets (the detailed historical data is a set of daily historical data and a set of detailed intraday data; the daily historical data comprises the price of open, close, high, low, and volume of a day; the detailed intraday data comprises price, volume, news and their corresponding time of the trading day minute by minute in great details).

The method may be a simulation and game method as described above, further comprising a multi-investments simulation with daily investment chart and intraday investment chart method comprising the steps of: allowing a user to place orders, set warnings, set conditions, and set triggers at any moment of a simulation day on the simulated investments by using the Visualized Setting Method; allowing a user to execute buys and sells at any moment of a simulation day on the simulated investments at the price of that moment; allowing a user to see daily investment charts displaying any moment of the simulated investment markets during a simulation day; allowing a user to see a intraday investment charts on a screen displaying any moment of the simulated investment markets during a simulation day (the intraday investment charts are automatically advancing from their open to the close of the simulation day); allowing a user to adjust the advancing speed of the intraday investment charts at any time; advancing all of the intraday investment charts at the same speed at any time; allowing a user to pause and resume the advancement of the intraday investment charts at any time; automatically pausing the advance of the intraday investment charts if buy or sell selected from the choosing investment vehicle to give a user an opportunity to finish the buy or sell operation; synchronizing the movement of daily investment charts with the movement of their corresponding intraday investment charts all the time during the simulation; allowing a user to switch to other screens and switch back if more than one screen is defined for the simulation; allowing a user to quickly find a screen and switch to the screen; allowing a user to transfer funds between trading account and saving account at any time; allowing a user to start the next simulation day (this step can be repeated to move the simulation forward until the end of the simulation); allowing a user to select an investment vehicle at any time at each of the simulation day; allowing a user to select buy or sell after an investment vehicle is selected; allowing a user choose a position to sell from the portfolio if sell is selected; allowing a user to select the amount of money to use for a buy or amount of money to reclaim for sell; allowing a user to execute the buy or sell or to confirm an order; and optionally repeating some or all of the steps above.

The method may be an investment chart based interactive trade simulation training and game method comprising the steps of: using at least one computer, where a computer is a personal computer, or a video game device, or a network server, or a hand-held computing or communication device; using at least one database accessible by the computer, wherein the database comprises real historical information for a plurality of investments, and wherein the database optionally comprises simulation settings for the investments; executing software on the computer that generates a simulation interface displayed on one or more screens, and wherein the simulation interface comprises one or more investment charts using the real historical data from the database; and providing one or more players or users the ability to interact with the simulation interface and execute investment decisions within one or more simulated markets, wherein the markets are simulated based on the historical data; optionally providing an internet connection that enables the player to access historical information from servers and communicate with other people all over the world; selecting an investment symbol by a user; selecting a start date by a user; providing a separated trading account and a saving account; providing a charting method optionally hides prices and dates on the investment chart(s) from user during the simulation based on the user's selection; providing a Compressed Time Simulation Method allowing the simulation of the investment(s) being conducted in a compressed manner with respect to time; providing a General Trading Method of Investments and a General Trading Method of Investment Vehicles allowing a user to trade any investment through any investment vehicle in a unified and simplified manner; providing a Visualized Setting Method for a user to set orders, warnings, conditions and triggers on the investment charts directly; providing a Auto-recoding and Playback Method to automatically record the user's trade operations during the simulation; and providing a online investment simulation competition method that allows people all over the world to conduct the investment simulation competition through internet.

The method may be an investment chart based interactive trade simulation training and game method as described above, further comprising an online investment simulation competition method comprising the steps of: providing an investment simulation that simulates one or more investments for which trading can occur with at least one investment chart; providing an online chatting method to allow a user to chat with other players all over the world, to start a competition or join a started competition; and providing a score board to dynamically display the changing money other players earned throughout the competition. It may also or alternatively comprise a step allowing synchronous online investment simulation competition by using a Synchronous Competition Method. The Synchronous Competition Method may comprise the steps of: halting a player advance to next day if any one of the player in the competition has not finish the simulation of the day (although he can still do other operations); enabling a player been halted to advance to the next day after all of the players in the competition finish the simulation of the day; selecting a main symbol of a simulation by the initial player; selecting a start date of a simulation by the initial player; and/or deciding an end date through online chatting by all of the participants of the competition. In addition, the method may additionally or alternatively comprise allowing asynchronous online investment simulation competition using an Asynchronous Competition Method. The Asynchronous Competition Method may comprise selecting a main symbol of a simulation by the initial player; selecting a start date of a simulation by the initial player; deciding an end date through online chatting by all of the participants of the competition; and

allowing each player do the investment simulation at his own pace.

The method may be an investment chart based interactive trade simulation training and game method comprising the steps of: using at least one computer, where a computer is a personal computer, or a video game device, or a network server, or a hand-held computing or communication device; using at least one database accessible by the computer, wherein the database comprises real historical information for a plurality of investments, and wherein the database optionally comprises simulation settings for the investments; executing software on the computer that generates a simulation interface displayed on one or more screens, and wherein the simulation interface comprises one or more investment charts using the real historical data from the database; and providing one or more players or users the ability to interact with the simulation interface and execute investment decisions within one or more simulated markets, wherein the markets are simulated based on the historical data; optionally providing an internet connection that enables the player to access historical information from servers and communicate with other people all over the world; selecting an investment symbol by a user; selecting a start date by a user; providing a separated trading account and a saving account; providing a charting method optionally hides prices and dates on the investment chart(s) from user during the simulation based on the user's selection; providing a Compressed Time Simulation Method allowing the simulation of the investment(s) being conducted in a compressed manner with respect to time; providing a General Trading Method of Investments and a General Trading Method of Investment Vehicles allowing a user to trade any investment through any investment vehicle in a unified and simplified manner; providing a Visualized Setting Method for a user to set orders, warnings, conditions and triggers on the investment charts directly; providing a Auto-recoding and Playback Method to automatically record the user's trade operations during the simulation; and providing a 2-in-1 method of combining an investment simulation and video game, where the 2-in-1 method allows a user to do the investment simulation while playing a video game.

The method may be an investment chart based interactive trade simulation training and game method as described above, wherein a 2-in-1 method comprises the steps of: providing an investment simulation that simulates one or more investments for which trading can occur with at least one investment chart; and providing a video game in which player's win or loss is based on his performance in the investment simulation; and allowing a player turn on/off the video game at any time. The 2-in-1 method may allow the video game to be played session by session where one session corresponds to one simulation trading day. A session of the video game can be started immediately after the opening of each simulation day; when a session of the game is over, the market is closed also for that simulation trading day. Another session of video game can be started when the next trading day is open. The 2-in-1 method may comprise a step where the video game includes lectures on investment knowledge and investment strategies. The 2-in-1 method may comprise steps wherein, within the video game, a player is occasionally presented with one or more encouraging or discouraging messages regarding his investments and investment strategy during the investment simulation. The 2-in-1 method may comprise steps wherein the difficulty of the video game increases or decreases based on the performance of a user using the investment simulation. The 2-in-1 method may comprise steps wherein the playing length of a video game for each session will be affected by the skills the player plays the video game: the better playing of the video game by a player, the longer the video game session last. The video game may provide scores to rate the skills the players playing the video game.

In preferred embodiments, the method is a method for simulating a single investment with at least one data chart. In other preferred embodiments, the method is a method for simulating a single investment with one daily investment chart and one intraday investment chart. In other preferred embodiments, the method is a method of simulating multiple investments with one daily investment chart for each of the investment been simulated. In yet other preferred embodiments, the method is a method of simulating multiple investments with one daily investment chart and one intraday investment chart for each of the investment been simulated. In further embodiments, the method is an on-line investment simulation competition method in which players compete against each other based on how much money the player earned. In yet further embodiments, the method is a 2-in-1 investment simulation and video game.

In another aspect, the invention provides a storage medium comprising the computer program and/or method. The storage medium may be any medium that is suitable for storage of a computer program, including, but not limited to, a computer disk, such as a floppy disk, an optical computer disk, such as a compact disk (CD) or a digital virtual disk (DVD), a memory stick or flash drive, a hard disk, and random access memory (RAM). Thus, the storage medium may be a portable storage medium, such as one that is designed for easy connection and disconnection from a computer. Accordingly, the storage medium is suitable for use in a computer or computer network, and may be removable and portable (e.g., an external hard drive) or may be an integral, non-portable part of a computer or computer network (e.g., an internal hard drive).

The storage medium comprises some or all of the instructions for carrying out the method and program of the invention when used in conjunction with a computer comprising a processor that processes computer instructions. In embodiments, the storage medium comprises some or all of the executable files for the computer program. In embodiments, the storage medium comprises some or all of the data files for markets that can be displayed by the computer program. In some embodiments, the storage medium comprises data files that are updates of original data relating to some or all of the markets. In yet other embodiments, the storage medium comprises executable and/or data files that are updates of the computer program. Embodiments include combinations of updated and original executable and data files. Thus, in embodiments, the storage medium comprises a computer program, wherein the computer program is capable of running on a computer and comprises instructions for: simulating at least one market in which trading can occur using historical data and other information from that market; and displaying the data and information to a user in a form comprising at least one chart.

In another aspect, the invention provides a computer or computer network comprising the program or method of the invention. The computer may be any type of computer, including, but not limited to, a personal computer, a network server, a video game device, and a hand-held computing or communication device (e.g., PDA, mobile phone). The program may be present on the computer in a stable, long-term form, such as in the form of a computer program stored on a storage medium. Alternatively, the program may be present on the computer in an ephemeral form, such as in RAM. The computer or computer network may, of course, comprise only a portion of the program, for instance data files relevant to the user's actions (e.g., investments, performance, data relative only to particular investments, value of portfolio, etc.). In addition to comprising the computer program, the computer comprises at least one processor for processing the instructions contained within the computer program. The processor may be any processor capable of executing computer instructions, such as, but not limited to, a central processing unit (CPU). The computer also preferably comprises at least one monitor to display information generated by the processor(s) from instructions from the computer program. The monitor preferably is capable of displaying one or more investment charts, and optionally other information that is relevant to those charts and the user of the computer program. Other hardware and software typically found on a computer, such as one or more hard drives, floppy disk drives, optical disk drives, speakers, printers, a mouse, an operating system (e.g., Windows, Mac OS, Linux or other UNIX based systems), and the like may comprise parts of the computer.

Accordingly, the computer comprises means for storing, either permanently, semi-permanently, or ephemerally, some or all of the computer program of the invention; means for executing some or all of the executable files of the computer program; means for accessing some or all of the data files of the computer program, and preferably also some or all of the data files that are created by the computer program for one or more users; means for displaying information generated as a result of running the computer program; and optionally means for storing data generated as a result of running the computer program. By permanent storage, it is meant storage in a form that is not removable without destruction of the portion of the computer on which the computer program is stored. By semi-permanent storage, it is meant storage in a form that continues to exist on a computer after the computer power is turned off, but which may be removed by actions of a user (e.g., stored on a hard drive). By ephemeral storage, it is meant storage in a form that is easily removed from a computer, through the normal operation of the computer (e.g., stored in RAM).

In yet a further aspect, the invention provides a system for simulating one or more markets or sub-markets. In general, the system comprises hardware and software, where the software is the software of the present invention and the hardware is capable of running the software. In typical embodiments, the hardware is one or more computer comprising the software of the invention, and one or more processors capable of running the computer program. In embodiments, multiple computers comprise and run the program, each comprising some or all of the program and executing some of the instructions or providing some of the data for the program. In one particular embodiment, the system is an Internet-based system in which multiple players may compete against each other to amass the most valuable investment portfolio over a given time period. In other embodiments, the system is a system of multiple computers in a network, where the network is administered by a professional in the education field or investing field, and where the system is used for instruction and teaching of investing principles and techniques.

The system thus may comprise a single computer running the software, or multiple computers, each running a copy of the software or some or all sharing the software. The system thus may be a personal computer or a network of computers, such as the Internet or an intranet. In general, the system, regardless of its particular configuration, is used to run the computer program of the present invention.

The present invention further provides not only a real-world trading environment but also a simple and easy to use system. Such a system is achieved by simplifying many sophisticated investment vehicles, such as option and future, and unifying the trading steps of different markets such as stock, currency, and commodities. This makes it a general and genuine trading system that can simulate any market for which movement can be described by investment charts. The system can also simulate any investment vehicle, such as, but not limited to, stock, option, future, spread, and CFD. Due to the simplicity of the system from the standpoint of use, it has broad applicability as not only a training system for investment professionals, but as a form of entertainment, fun, and learning for the general population.

The present invention also provides a system and method to help players read charts and technical indicators, spot patterns, gain valuable technical analysis skills, and develop working strategies that fit their personal characters. At the same time, it also helps them understand what discipline and a good money management really means and how important they are to a successful investment strategy.

The present invention further provides a system and method that use two or more investment charts to dynamically present market movement of one or more markets or sub-markets. For example, a daily investment chart uses bars to describe market movement, where each bar presents the price of open, close, high, and low of a day. Such a chart gives the player a picture of the market's longer term trend. In addition, for example, an intraday investment chart uses bars or lines to represent the market price movement in minutes of one day or several days selected. Such an investment chart gives the player the detailed market movement over a relatively short period. By watching these two dynamic investment charts, the player can gain a broader view and a clear picture about the status of the market. In embodiments, more charts are included for viewing the market from other angles.

The system and method of the invention can allow players to watch the movement of unlimited stocks, currencies, commodities, bonds, etc. at the same time. It also can allow for simulating different markets at the same time. In some embodiments, it also allows simulating some sophisticated trading strategies like hedgy, where one may BUY a stock and buy PUT of the same stock at the same time to reduce the market risk.

Thus, in embodiments, the invention provides an investment chart based interactive trade simulation training and game system, where the system comprises: one or more computers; one or more databases accessible by the computer, wherein the database has real historical information for a plurality of investments, and wherein the database optionally comprises simulation settings for the investments; an optional internet connection that enables the system to work on-line and a player to communicate with other people all over the world; software executing on the computer to generate a simulation interface displayed on one or more screens, and wherein the simulation interface comprises one or more investment charts using the real historical data from the database; and one or more users or players interact with the simulation interface and execute investment decisions within one or more simulated investment markets, wherein the investment markets are simulated based on the historical data; software executing on the computer for single investment simulation with daily investment chart; software executing on the computer for single investment simulation with daily investment chart and intraday investment chart; software executing on the computer for multi-investments simulation with daily investment chart; software executing on the computer for multi-investments simulation with daily investment chart and intraday investment chart; software executing on the computer for online investment simulation competition; and software executing on the computer for a 2-in-1 simulation combining investment simulation and video game. The software may be provided as two or more discrete programs or all of the software may be provided in a single unit, such as by way of a single piece of software. Typically, the computer is a personal computer, video game device, network server, or hand-held computing or communication device, or a combination of two or more of these. In addition, typically, the system simulates investments in a compressed manner with respect to time. Compression of time can cause the simulated investment market to run at X minutes of historical market time per one second of real time, where X can be any number ranging from 1 (e.g., 1 minute) to 1440 or higher (e.g., 1440 minutes, or 1 day).

In embodiments, the system simulates investments with a start date, wherein the start date is: 1) randomly selected by the system; 2) specified by a player; 3) specified in one or more files selected by the player; or 4) predefined in the system. Alternatively or in addition, the system can display investment data in a form of one or more investment charts on one or more display screens, wherein the system optionally conceals prices and dates on the investment charts from the player during the simulation.

In some embodiments, the system further comprising a Simulation Setting System (sub-system); wherein the Simulation Setting System collects the following information: a main symbol for the simulation to be defined; a simulation mode for the simulation to be defined; screen definitions if multi-investments simulation is involved, which are provided with the help of a Multi-screens Definition System; settings for different investment vehicles if multi-investment vehicles are involved in the simulation; and parameters for trading. The Multi-screens Definition System can define screens by collecting the following information: a screen ID number for each screen to be defined; a screen name for each screen to be defined; investment symbols and their layout on the screen for each screen to be defined; and optionally define more screens by collecting the above information for each screen.

The system of the invention may comprise instructions for: providing a separate trading account and a saving account for the player, wherein funds may be transferred between the two accounts; and/or a General Trading System of Investments and a General Trading System of Investment Vehicles, which allow a player to trade any investment through any investment vehicle in a unified and simplified manner. Where provided, the General Trading System of Investment and General Trading System of Investment Vehicles can allow a player to trade any investment through any investment vehicle by the following steps: optionally choosing a trading vehicle; choosing buy or sell of the selected trading vehicle for a trade by a player and further choosing a position to sell if sell is chosen and the player has more than one position; optionally deciding a money amount used to buy or a money amount reclaimed for sell; optionally executing a buy or sell choice or confirming an order; wherein none, one, two or three of the optional steps are performed. The amount to buy or amount reclaim for sell can be expressed in any way, such as an amount of money, a percentage of money available, or a percent of an available amount of a position. The General Trading System of Investment Vehicles can have a Trade Engine to select an appropriate specific trade engine to handle the specific trading details of the selected trading vehicle and find out the Initial_Value and Initial_Unit_Price of a position if it is a buy, or the Money_Reclaim and New_Initial_Value if it is a sell. Furthermore, the General Trading System of Investment Vehicles can be applied to a new investment vehicle that might be created in the future by creating a new trade engine for the new investment vehicle and plug it to Trade Engine of said General Trading System of Investment Vehicles.

In embodiments, the system further comprises a Visualized Setting System, wherein the Visualized Setting System 1) provides graphic cues on the investment chart; 2) allows a player to move the graphic cues to a appropriate price level on the investment chart to set price desired and; and 3) allows the player to set warnings, open orders, set conditions, and set triggers after a desired price has been set. In yet other embodiments, the system additionally or alternatively comprises an Auto-recoding and Playback System to automatically record the player's trade operations during the simulation. The Auto-recoding and Playback System can: 1) allow a player to write down the reasons for buying or selling a position that will be recorded by the system; 2) optionally provide investment charts to help the player to better review the trading records; 3) provide one or more tables to display the recorded trading records; 4) connect a record in the table to a bar of the investment chart by the trading date; wherein if a record in the table is clicked, the bar represent the day which the trade happened will be automatically bring onto the investment chart and a dashed line indicating the price level will appear; and 5) automatically record the trading information of the following: trading date showing the date when a simulated trade happened; trade action, which is either buy or sell; position name, which is the name of a position; trade price, which is the price for buying or selling a position of a simulated trade; trade ratio, which is the ratio of money used to money available or ratio of position sold to positions available; money lost with time, which gives the player an idea what time worth money means in option and future trading.

In embodiments, the system comprises software for multi-investments simulation, which permits unlimited investments to be simulated with the help of an Unlimited Investments Simulation System. The Unlimited Investments Simulation System can: 1) allow a player to divide and group multi-investments into one or more computer screens, wherein each screen can display a limited number investment charts, but the number of screens is unlimited; 2) present the screen which held at least one investment chart for each investment being simulated; 3) provide a system for quickly switching between screens; and 4) provide a search system to locate a screen or the screen held an investment symbol been searched and quickly display the searched screen. Alternatively or in addition, the Unlimited Investments Simulation System: 1) optionally has unified historical data for all investments by making historical data of all investments having the same trading days each year. A dummy day is added to the historical data of an investment if any day is missing. The close price of the previous day is used as the price of the open, close, high, and low of the dummy day. In addition or alternatively, the system may comprise a system to handle a missing day in the historical data by adding a line on the daily investment chart next to the bar representing the previous day to indicate the missed day during the simulation. The Unlimited Investments Simulation System may also have a Globalize Timing System to time the simulation order of different investments if global market investment simulation involved. The Globalize Timing System comprises: dividing 24/5 continuous markets, like currency markets, into discontinuous markets; using 5 pm EST of the United States of America as the close time of the current trading session (day) and the open time of the next trading session (day). Markets all over the world will be simulated in the order based on that start time; using the market price at 5 pm EST of the United States of America as the close price of the current trading session (day) and the open price of the next trading session (day). Furthermore, the Unlimited Investments Simulation System may provide a synchronized simulation for all investments been simulated at any moment. In some configurations, the system comprises a Missing Data Handling System to smoothly handle many complicated situations relating to missing data.

Thus, in embodiments, the invention provides an investment chart based interactive trade simulation training and game system, where the system comprises: one or more computers; one or more databases accessible by the computer, wherein the databases have real historical information for a plurality of investments, and wherein the databases optionally comprise simulation settings for the investments; an optional internet connection that enables the system to work on-line and a player to communicate with other people all over the world; software executing on the computer to generate a simulation interface displayed on one or more screens, and wherein the simulation interface comprises one or more investment charts using the real historical data from the database(s); and one or more users or players interact with the simulation interface and execute investment decisions within one or more simulated investment markets, wherein the investment markets are simulated based on the historical data.

The system may be a simulation and game system as described above, wherein the system further comprises a single investment simulation with daily investment chart system that has the following functions: allowing a user to see a daily investment chart displaying the moment when the simulated investment market is opening and allowing him to place orders, set warnings, set conditions, and set triggers at the open of a trading day of the simulated investment market by using the Visualized Setting System; allowing a user to see a daily investment chart displaying the moment when the simulated investment market is opening and allowing him to execute buys or sells at the open price of the trading day immediately; allowing a user to see a daily investment chart displaying the moment when the simulated investment market is closing and allowing him to execute buys or sells at the close price of a trading day immediately; allowing a user to see a daily investment chart displaying the moment when a stop loss threshold of any position held by the user is reached during a simulation day and allowing him to execute buys or sells at the stop loss price immediately; allowing a user to see a daily investment chart displaying the moment when a preset warning price is found reached during a simulation trading day and allowing him to execute buys or sells at that warning price immediately; allowing a user to select an investment vehicle at the points mentioned above; allowing a user to select buy or sell after an investment vehicle is selected; allowing a user choose a position to sell from the portfolio if sell is selected; allowing a user to select the amount of money to use for buy or amount of money to reclaim for sell; allowing a user to execute the buy or sell or to confirm an order; allowing a user to transfer funds between a trading account and a saving account at any time; allowing a user to start the next trading day (this step can be repeated to move the simulation forward until its end); and optionally repeating some or all of the steps above.

Thus, in embodiments, the invention provides an investment chart based interactive trade simulation training and game system, where the system comprises: one or more computers; one or more databases accessible by the computer(s), wherein the databases have real historical information for a plurality of investments, and wherein the databases optionally comprise simulation settings for the investments; an optional internet connection that enables the system to work on-line and a player to communicate with other people all over the world; software executing on the computer(s) to generate a simulation interface displayed on one or more screens, and wherein the simulation interface comprises one or more investment charts using the real historical data from the database(s); and one or more users or players interact with the simulation interface and execute investment decisions within one or more simulated investment markets, wherein the investment markets are simulated based on the historical data.

The system may be a simulation and game system as described above, wherein the system further comprises a single investment simulation with daily investment chart and intraday investment chart system that has the following functions: allowing a user to place orders, set warnings, set conditions, and set triggers at any moment during a simulation trading day on the simulated investment by using the Visualized Setting System; allowing a user to execute buys and sells at any moment of a simulation trading day on the simulated investment at the price of that moment; allowing a user to see a daily investment chart displaying any moment of the simulated investment market during a simulation day; allowing a user to see a intraday investment chart displaying any moment of the simulated investment market during a simulation day (the intraday investment chart is automatically advancing from the open of the investment market to its end); allowing a user to see a multi-day intraday chart; allowing a user to adjust the advancing speed of the intraday investment chart at any time; allowing a user to pause and resume the advance of the intraday investment chart at any time; automatically pausing the advance of the intraday investment chart if buy or sell selected from the choosing investment vehicle to give a user an opportunity to finish the buy or sell operation; synchronizing the movement of daily investment chart with the movement of intraday investment chart all the time during the simulation; allowing a user to transfer funds between trading account and saving account at any time; allowing a user to start the next simulation trading day (this step can be repeated to move forward the simulation until its end); allowing a user to select an investment vehicle at the points mentioned above; allowing a user to select buy or sell after an investment vehicle is selected; allowing a user choose a position to sell from the portfolio area if sell is selected; allowing a user to select the amount of money to use for a buy or amount of money to reclaim for sell; allowing a user to execute the buy or sell or to confirm an order; and optionally repeating some or all of the steps above.

Thus, in embodiments, the invention provides an investment chart based interactive trade simulation training and game system, where the system comprises: one or more computers; one or more databases accessible by the computer(s), wherein the databases have real historical information for a plurality of investments, and wherein the databases optionally comprise simulation settings for the investments; an optional internet connection that enables the system to work on-line and a player to communicate with other people all over the world; software executing on the computer(s) to generate a simulation interface displayed on one or more screens, and wherein the simulation interface comprises one or more investment charts using the real historical data from the database(s); and allowing one or more users or players to interact with the simulation interface and execute investment decisions within one or more simulated investment markets, wherein the investment markets are simulated based on the historical data.

The system may be a simulation and game system as described above, wherein the system further comprises a multi-investments simulation with daily investment chart system that has the following functions: allowing a user to see multiple daily investment charts on a screen displaying the moment when the simulated investment markets are opening and allowing him to place orders, set warnings, set conditions, and set triggers at the open of a day of the simulated investment markets on those daily investment charts by using the Visualized Setting System; allowing a user to see multiple daily investment charts on a screen displaying the moment when the simulated investment markets are opening and allowing him to execute buys or sells at the open prices of those investments of a day immediately; allowing a user to see multiple daily investment charts on a screen displaying the moment when the simulated investment markets are closing and allowing him to execute buys or sells at the close prices of those investments of a day immediately; allowing a user to see multiple daily investment charts on a screen displaying the moment when a stop loss threshold of any position held by the user is reached during a simulation day and allowing him to execute buys or sells at the stop loss price immediately; allowing a user to see multiple daily investment charts on a screen displaying the moment when a preset warning price is found reached during a simulation day and allowing him to execute buys or sells at that warning price immediately; allowing a user to select an investment vehicle at any point mentioned above; allowing a user to select buy or sell after an investment vehicle is selected; allowing a user choose a position to sell from the portfolio if sell is selected; allowing a user to select the amount of money to use for a buy or amount of money to reclaim for sell; allowing a user to execute the buy or sell or to confirm an order; allowing a user to switch to other screens and switch back if more than one screen is defined for the simulation; allowing a user to quickly find a screen and switch to the screen found; allowing a user to transfer funds between a trading account and a saving account at any time; allowing a user to start the next trading day (this step can be repeated until the end of the simulation); and optionally repeating some or all of the steps above.

Thus, in embodiments, the invention provides an investment chart based interactive trade simulation training and game system, where the system comprises: one or more computers; one or more databases accessible by the computer(s), wherein the databases have real historical information for a plurality of investments, and wherein the databases optionally comprise simulation settings for the investments; an optional internet connection that enables the system to work on-line and a player to communicate with other people all over the world; software executing on the computer(s) to generate a simulation interface displayed on one or more screens, and wherein the simulation interface comprises one or more investment charts using the real historical data from the database(s); and allowing one or more users or players to interact with the simulation interface and execute investment decisions within one or more simulated investment markets, wherein the investment markets are simulated based on the historical data.

The system may be a simulation and game system as described above, wherein the system further comprises a multi-investments simulation with daily investment chart and intraday investment chart system that has the following functions: allowing a user to place orders, set warnings, set conditions, and set triggers at any moment of a simulation day on the simulated investments by using the Visualized Setting System; allowing a user to execute buys and sells at any moment of a simulation day on the simulated investments at the price of that moment; allowing a user to see daily investment charts displaying any moment of the simulated investment markets during a simulation day; allowing a user to see intraday investment charts on a screen displaying any moment of the simulated investment markets during a simulation day (the intraday investment charts are automatically advancing from their open to the close of the simulation day); allowing a user to adjust the advancing speed of the intraday investment charts at any time; advancing all of the intraday investment charts at the same speed at any time; allowing a user to pause and resume the advancement of the intraday investment charts at any time; automatically pausing the advance of the intraday investment charts if buy or sell selected from the choosing investment vehicle to give a user an opportunity to finish the buy or sell operation; synchronizing the movement of daily investment charts with the movement of their corresponding intraday investment charts all the time during the simulation; allowing a user to switch to other screens and switch back if more than one screen is defined for the simulation; allowing a user to quickly find a screen and switch to the screen; allowing a user to transfer funds between a trading account and a saving account at any time; allowing a user to start the next simulation day (this step can be repeated to move the simulation forward until the end of the simulation); allowing a user to select an investment vehicle at any time at each of the simulation day; allowing a user to select buy or sell after an investment vehicle is selected; allowing a user to choose a position to sell from the portfolio if sell is selected; allowing a user to select the amount of money to use for a buy or amount of money to reclaim for sell; allowing a user to execute the buy or sell or to confirm an order; and optionally repeating some or all of the steps above.

Thus, in embodiments, the invention provides an investment chart based interactive trade simulation training and game system, where the system comprises: one or more computers; one or more databases accessible by the computer(s), wherein the databases have real historical information for a plurality of investments, and wherein the databases optionally comprise simulation settings for the investments; an optional internet connection that enables the system to work on-line and a player to communicate with other people all over the world; software executing on the computer(s) to generate a simulation interface displayed on one or more screens, and wherein the simulation interface comprises one or more investment charts using the real historical data from the database(s); and allowing one or more users or players to interact with the simulation interface and execute investment decisions within one or more simulated investment markets, wherein the investment markets are simulated based on the historical data.

The system may be a simulation and game system as described above, wherein the system further comprises an online investment simulation competition system that has the following functions: providing an investment simulation that simulates one or more investments for which trading can occur with at least one investment chart; providing an online chatting system to allow a user to chat with other players all over the world, to start a competition or join a started competition; and providing a score board to dynamically display the changing money other players earned throughout the competition. It may also or alternatively allow a synchronous online investment simulation competition by using a Synchronous Competition System. The Synchronous Competition System may have the following functions: halting a player from advancing to the next day if any one of the players in the competition has not finished the simulation of the day (although he can still do other operations); enabling a player who has been halted to advance to the next day after all of the players in the competition finish the simulation of the day; selecting a main symbol of a simulation by the initial player; selecting a start date of a simulation by the initial player; and/or deciding an end date through online chatting by all of the participants of the competition. In addition, the system may additionally or alternatively allow an asynchronous online investment simulation competition using an Asynchronous Competition System. The Asynchronous Competition System may have the following functions: selecting a main symbol of a simulation by the initial player; selecting a start date of a simulation by the initial player; deciding an end date through online chatting by all of the participants of the competition; and allowing each player to do the investment simulation at his own pace during the simulation.

Thus, in embodiments, the invention provides an investment chart based interactive trade simulation training and game system, where the system comprises: one or more computers; one or more databases accessible by the computer(s), wherein the databases have real historical information for a plurality of investments, and wherein the databases optionally comprise simulation settings for the investments; an optional internet connection that enables the system to work on-line and a player to communicate with other people all over the world; software executing on the computer(s) to generate a simulation interface displayed on one or more screens, and wherein the simulation interface comprises one or more investment charts using the real historical data from the database(s); and allowing one or more users or players to interact with the simulation interface and execute investment decisions within one or more simulated investment markets, wherein the investment markets are simulated based on the historical data.

The system may be a simulation and game system as described above, wherein the system further comprises a 2-in-1 investment simulation and video game system that has the following functions: providing an investment simulation that simulates one or more investments for which trading can occur with at least one investment chart; and providing a video game in which a player's win or loss is based on his performance in the investment simulation; and allowing a player turn on/off the video game at any time. The 2-in-1 system may allow the video game to be played session by session where one session corresponds to one simulation trading day. A session of the video game can be started immediately after the opening of each simulation day; when a session of the game is over, the market is closed also for that simulation trading day. Another session of video game can be started when the next trading day is open. The 2-in-1 system may have a function that includes lectures on investment knowledge and investment strategies in the video game. The 2-in-1 system may comprise a function to occasionally present a player with one or more encouraging or discouraging messages regarding his investments and investment strategy during the investment simulation in the video game. The 2-in-1 system may comprise a function to increase or decrease the difficulty of the video game based on the performance of a user using the investment simulation. The 2-in-1 system may comprise functions to increase or decrease the playing length of a video game for each session based on the skills of the player playing the video game: the better playing of the video game by a player, the longer the video game session will last. The 2-in-1 system may provide scores to rate the skills of the players playing the video game.

Accordingly, the invention provides a computer system for simulating one or more investment markets, where the system comprises: 1) a computer program that: simulates one or more investment markets using real historical data, and displays to a user the historical data in one or more investment charts; and 2) at least one processor that is capable of executing the computer program. The markets can be simulated in a compressed manner with respect to time. It likewise provides a computer system comprising: a computer program that simulates and displays one or more investment markets or sub-markets using real historical data from those markets or sub-markets; and at least one processor for executing the program. The system may be implemented completely or partially over the Internet, and/or may provide a competitive investment simulation game.

The system and method of the invention can simulate not only markets with detailed intraday historical data but also markets with incomplete historical data (e.g., with only the daily open, close, high, and low). Moreover, the system can seamlessly simulate any market with inconsistent data. That is, it can seamlessly simulate a market having intraday data for some days, but not other days; or having data missing for a period of time in the intraday data.

One additional aspect is the presence of one or more game features within the system. The system is both an instructional tool and an entertainment vehicle. Players, be they ordinary people or professional traders, can use the system, method, and computer program as a game, playing it alone or with one or more others in a network, such as a local network or wide area network. Indeed, players may play others from all over the world where the network is the Internet. In embodiments, players can chat with each other and share their trading experiences in real time; players can also share their drawings on the investment charts immediately and compete with each other in the simulation. The competition can be done synchronously or asynchronously. Within a gaming context, various goals of the players can be set, such as amassing money. Furthermore, within the context of gaming, players can learn lessons that are taught to investors or students in the investing field, such as performance of sectors of the market over time or under varying economic and seasonal conditions, including natural and man-made disasters (e.g., hurricanes, typhoons, volcanoes, tsunamis, war). They also may learn about a particular company stock, precious metal, national currency, etc. under varying economic, seasonal, etc. conditions.

Accordingly, in embodiments, the invention provides a method of combining an investment simulation and a video game, where the method comprises: providing an investment simulation that simulates one or more markets for which trading can occur; and providing a video game in which players win or lose based on their performance in the investment simulation. The beginning and ending of the video game can be based on one or more time points of the investment simulation. Furthermore, the video game can includes instructions or tips on investment strategies, and the difficulty of the video game can increase or decrease based on the performance of a user using the investment simulation. In some configurations, the video game includes the option to make changes in the investment simulation during the video game. For example, within the video game, players might be presented with one or more encouraging or discouraging messages regarding their investment strategy in the investment simulation. Of course, in view of the above disclosure, the invention provides a computer program comprising instructions for performing this method, and a computer system comprising: a computer program containing instructions for performing the method; and at least one processor capable of executing the computer program. At least part of the system may be connected to the Internet. As such, the system and method may be a combined Internet investment simulation and video game competition.

In yet a further aspect, the invention provides a method of doing business using a computer or computer system. The method comprises providing a computer program according to the invention on a computer connected to the Internet, and charging a fee for use of the program. Multiple entities may be involved in sale of the computer program, although it is typical that only one entity is involved. For example, the owner of the computer program may make the program available for download over the Internet, and charge money for others to download the program to their computer. Alternatively, an intermediary seller may charge an ultimate consumer for the download, and then connect the user to a web site containing the program for downloading. Likewise, the software may be downloaded and stored on a CD, and the CD sold either directly or through an intermediary to an end user, who will receive the CD through normal shipping channels.

The fee for obtaining a personal copy of the software or for using the software over a network may be charged for use of the program over the Internet (i.e., for access to a website running the program). Alternatively, the fee may be charged for downloading of the computer program from a website on the Internet. Yet again, the fee may be charged for purchase of a portable storage medium comprising the computer program (e.g., a CD to be shipped to the purchaser). The fee may be paid by way of any known process, including, but not limited to, credit card, electronic funds transfer, personal check, and cash. Funds may be directly forwarded to a seller of the program (e.g., by personal check to the seller) or indirectly forwarded to the seller (e.g., using PayPal or another payment processing service).

In one particular embodiment, the method of doing business includes providing the software of the invention on a computer attached to the Internet; and charging users a fee to use the program over the Internet. In embodiments, the fee is an entrance fee, which can be charged a single time or periodically (e.g., daily, weekly, monthly, yearly). In other embodiments, the fee is a connect charge, which is based on the amount of time a user is connected to the computer running the program. Where multiple users are connected at one time, for example in a gaming situation, multiple fees are charged at one time, and revenue generation is enhanced.

While applicable to use in a business method or a multi-user situation, one feature of the present systems, methods, and programs that is broadly provided is the ability to simulate any market for which data is available by importing the data into the program and using the data within the framework provided by the program. That is, regardless of the source of the data, the present invention can import the data, convert it to a form and format that is useful within the context of the invention, and display the data in a consistent and easily understandable form and format. Accordingly, the invention provides ease of use and simplicity of understanding for all users, regardless of their knowledge of the investments field. In addition, the invention makes it possible to easily and understandably play multiple markets at a single time, and optionally against multiple other players. Furthermore, because the invention is based on and uses real-world data from actual markets, it is a realistic recreation of markets, and is thus more helpful in training and more fun for gaming.

Turning now to the Figures, various features of embodiments of the invention will be described in detail. Those of skill in the art will understand that various other features may be provided within the context of the invention without departing from the spirit of the invention.

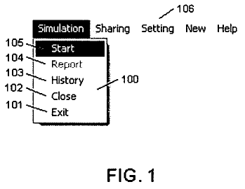

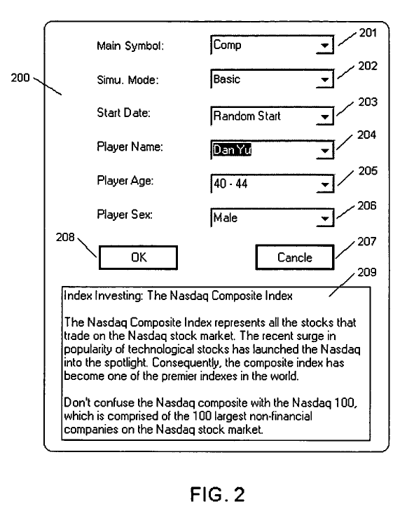

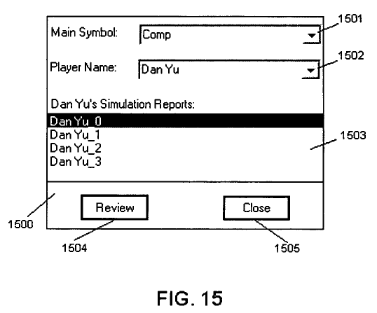

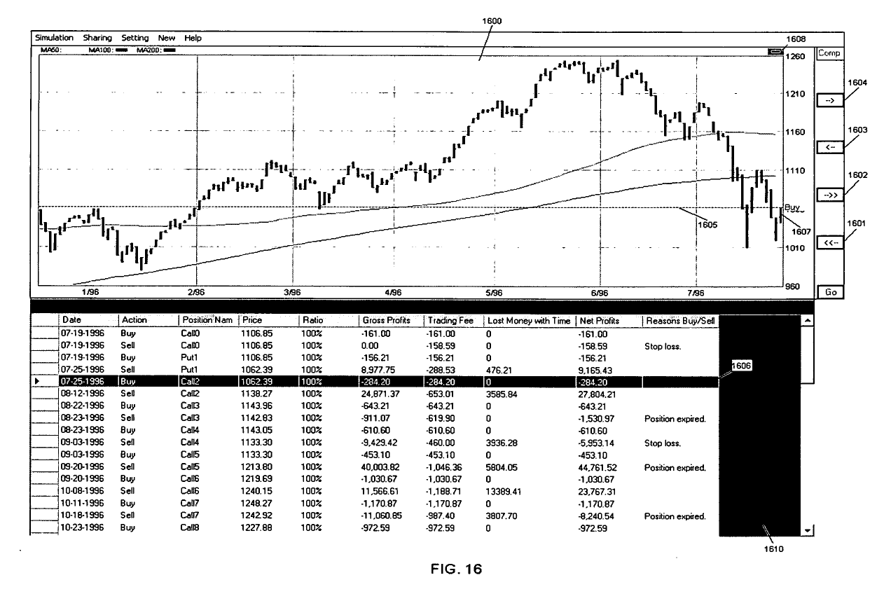

The main menu showing on FIG. 1 is the first screen displayed after logging in the investment chart based interactive trade simulation training and game system of present invention. A sub-menu 100 will pop up when clicking simulation on the main menu. There are five items in the sub-menu 100. Item exit 101, when clicked, enables a player to exit the system; item close 102 enables a player to close the current simulation; if item history 103 is clicked, a new form will pop up. It allows a player to select a recorded simulation file to review. This form will be described below with reference to FIG. 15; item report 104, if clicked, enables a player to study the records of current simulation. It will be discussed below reference to FIG. 16 also; if item start 105 is clicked, a getting start screen 200 will pop up as illustrated on FIG. 2.

FIG. 2 is a diagram illustrating the getting start screen of the simulation. Getting start screen 200 is comprised of 6 select fields, 2 buttons and 1 text field.

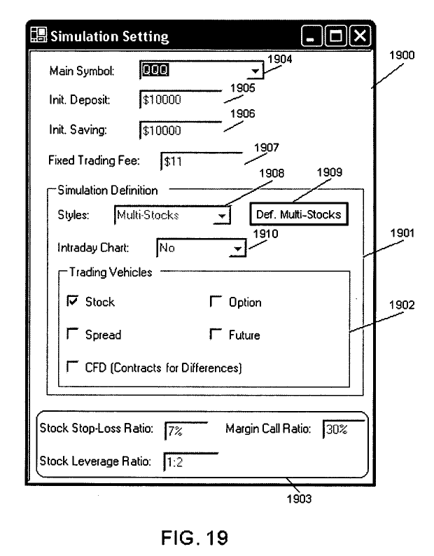

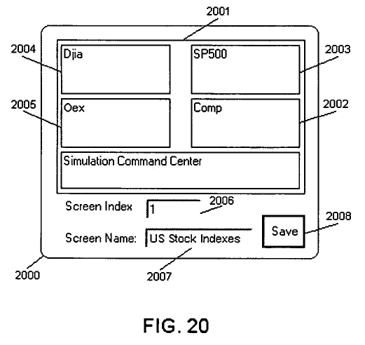

The investment chart based interactive trade simulation training and game system of the present invention can simulate any market and equities for which movement can be described by investment charts. It can simulate not only a single stock or currency or commodity but also unlimited stocks, currencies, commodities and other markets simultaneously. Selecting a symbol from the Main Symbol combo box field 201 allows a player to decide which stock, currency, or commodity to use for the simulation. To make it simple, no matter how complicated a player would like to conduct the simulation, the selection will be always the same: choose only one main symbol here. By default, the system always assumes a player would conduct a single investment simulation; if not, the player can define a customized simulation. The item setting 106 on the main menu illustrated on FIG. 1 is the place to launch the pre-define processes. It will be described below with reference to FIG. 19 and FIG. 20.

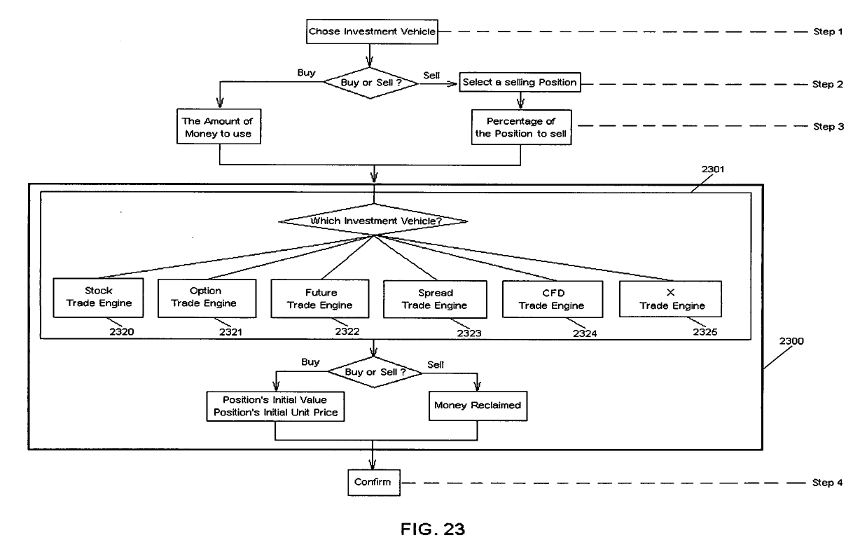

Four modes can be selected from Simu. Mode combo box field 202. These are Basic, Basic with Coach, Advance, and Advance with Coach. The Basic mode may be considered by some to be the most important mode. Anyone of any age can simulate any investment vehicle, such as complicated option, and future, with this mode. The trade simulation and game system of the present invention achieves this by hiding trading details of different investment vehicles, simplifying and unifying their trading steps. It allows a player to focus on the most important things of the trade. It will be discussed in detail later with reference to FIG. 23. The Basic with Coach mode gives a player additional instructions on how to read charts and technical indicators, how to identify patterns, etc. The Advance mode shows every detail hidden from the Basic mode. This will give the player opportunities to learn the details of different investment vehicles. The Advance mode with Coach System provides special instructions besides what the Advance mode provides.

There are four modes that can be selected from Start Date combo box field 203. The first one is Random Start. The system will randomly chose a start date from the earliest to the latest date of the historical data available. A specific start date can be entered here also. This is the second mode. The third mode allows a player to choose the start date of a recorded simulation report as the start date. This can be done by simply selecting a simulation report here. The last mode is the default mode, which uses a start date predefined in the system.

The system allows the player to enter his name, age and sex into Player Name combo box field 204, Player Age combo box field 205, and Player Sex combo box field 206. Once this information is entered, the system will record it automatically for later use.

Text field 209 is used to display the introduction of selected Main Symbol. Taking FIG. 2 as an example: the symbol of Nasdaq composite index Comp was selected in the Main Symbol combo box field 201. The introduction of the Nasdaq composite index is displayed here.

Cancel button 207, if clicked, would cancel all work done and go back to a previous screen. OK button 208, if clicked, launches the simulation.

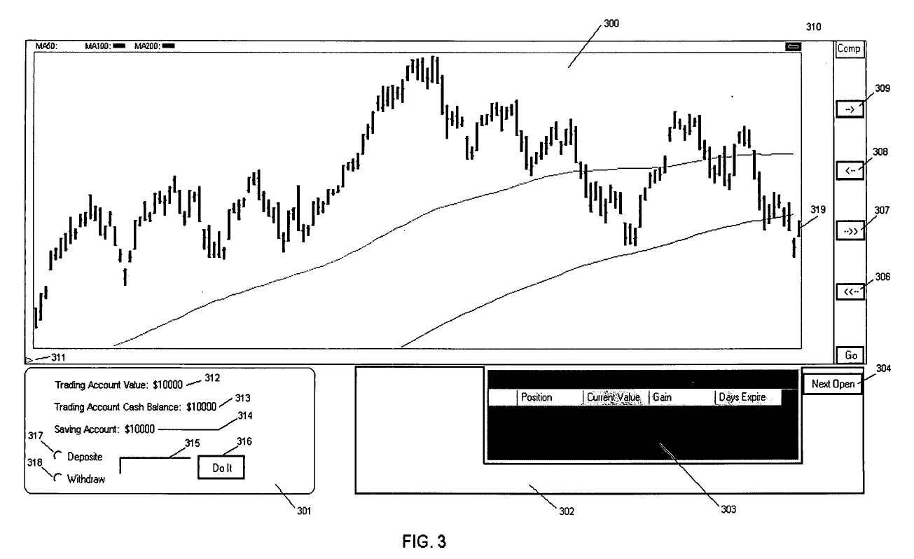

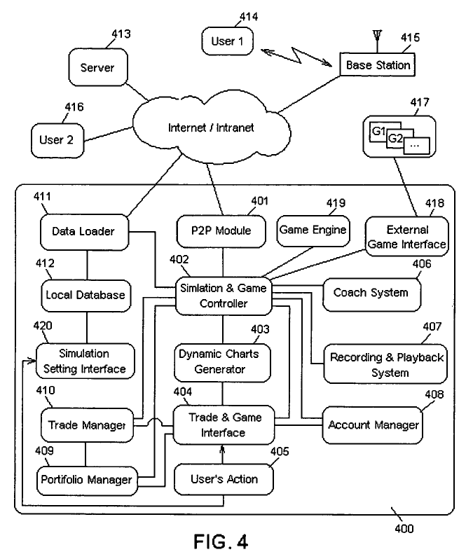

FIG. 3 is the first screen of a normal single investment simulation with a daily investment chart. Before discussing FIG. 3, a brief review of the architecture of the investment chart based interactive trade simulation training and game system of present invention is in order. FIG. 4 is a diagram illustrating the architecture of the trade simulation and game system. The system normally includes a computer or a computing device like palm, game boy, game machine, etc. and software running on the computer or computing device. The system can work alone or work together with servers or other systems running the same or compatible software through the Internet or an intranet. System 400 works with Server 413, User 1 414 and User 2 416 together through the Internet or an intranet. User 1 414 is connected to the Internet through a wireless system, for example. The software structure of the system is illustrated by system 400. Before starting a simulation, simulation parameters, mode, and layout can be set through Simulation Setting Interface 420. They will be saved into Local Database 412 or Server 413 depending on the configuration of the system. It will be discussed later with reference to FIG. 19 and FIG. 20. When starting the simulation, the Simulation & Game Controller 402 will request Data Loader 411 to load historical data and parameters, mode and layout associated with the simulation either from Local Database 412 or from Server 413 through the Internet. Upon the data loading, 402 will direct Dynamic Charts Generator 403 to recreate the historical investment charts that end at the date specified in Start Date combo box field 203 of FIG. 2. The player will interact with the system 400 through Trade & Game Interface 404. The Simulation & Game Controller 402 is essentially the brain of the system. It responds to requests from P2P Module 401, Data Loader 411, Trade Manager 410, Portfolio Manager 409, Trade & Game Interface 404, Account Manager 408, Recording & Playback System 407, Coach System 406, and Game Engine 419 or plug-in games 417 through External Game Interface 418 and directs them to work together accordingly. The P2P Module 401 is used to communicate with other players in the system directly or to systems used by other players. P2P stands for Peer to Peer. P2P is when multiple computers or computing devices think collectively towards a shared objective.

Computer programs that use fewer central servers and rely on a collection of computers, such as Gnutella, distributed media streaming etc. tend to be referred to as being more P2P. Computer programs where many end-users communicate with few central services tend to be referred to as being less P2P or not P2P. P2P technology is well known and is popular now. Its working mechanism will not be discussed here, as it is not critical to practice of the invention, and is well known. The External Game Interface 418 allows external games to be plugged-into the system of the present invention.

The bar Today 319 in the dynamic daily chart 300 of FIG. 3 is the latest day of the simulation. There are 5 buttons in the dynamic daily chart 300. If the --> button 309 is clicked, all bars on the chart will shift one bar toward the right side. If the -->> button 307 is clicked, all bars on the current chart will shift one screen toward the right, and all bars on the current chart would move out toward the right side. A player can use these 2 buttons to go back and review the history. If the <-- button 308 is clicked, the bars would shift one bar toward left side. If the <<-- button 306 is clicked, all bars on the chart would be shifted one screen toward the left side, and all bars on the current chart would move out toward the left side. These 2 buttons would be disabled if bar today 319 shows up. In other words, the player is not allowed to peek into the future. The system recreates the Nasdaq composite index daily chart of May 11, 2004, which is illustrated by dynamic daily chart 300; it brings the player back to that day and allows him to make an investment decision like it happened today. Investors using technical analysis on that day in history had seen the same chart as the Dynamic daily chart 300, and made their investment decision on May 11, 2004 based on that chart.

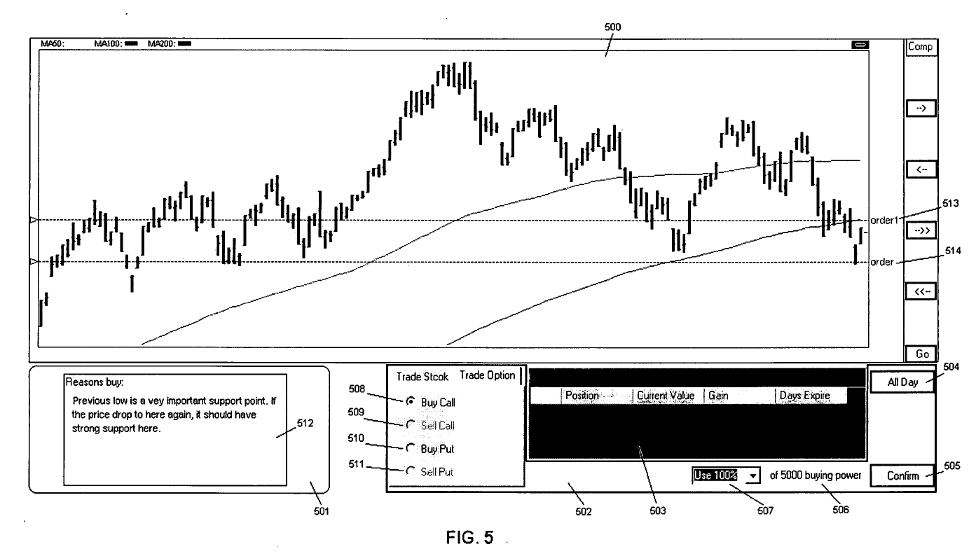

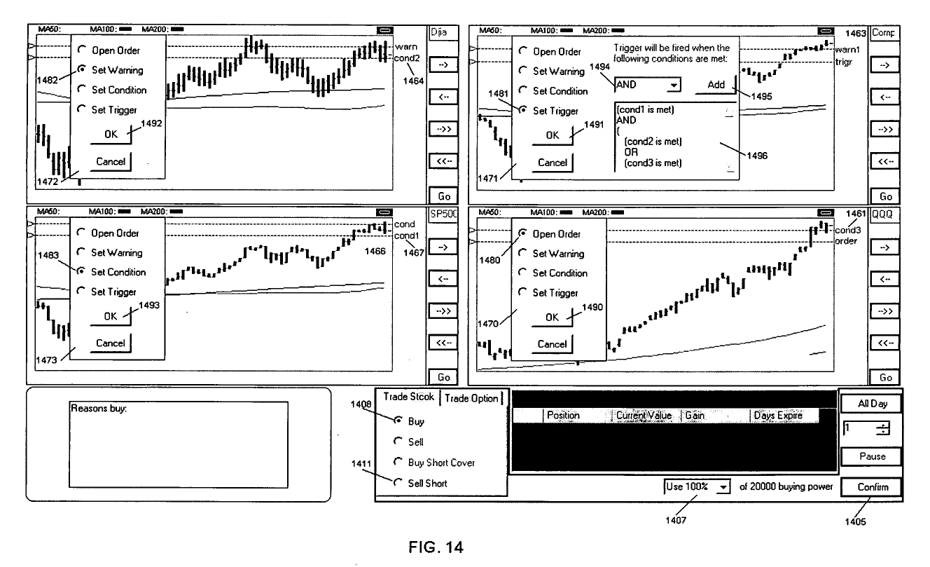

Price Setting Triangle 311 is used to open orders set triggers, warnings, or conditions of triggers. It will be discussed in detail later with reference to FIG. 14. Account management area 301 is the place for showing and managing the player's account information. A player is given 2 accounts. One is a trading account, the other is a saving account. The starting amount of money in these 2 accounts can be pre-defined. The default amount of money is $10000 each. This will be discussed later in greater detail with reference to FIG. 19. Only the money in the trading account can be used for trades. Player can deposit or withdraw money from each account as desired. For example, if radio button Deposit 317 is clicked, $1000 is entered into text field 315 and then Do It button 316 is clicked, $1000 will be deposited into the trading account. Now, Trading Account Value 312 and Trading Account Cash Balance 313 will be $11000 each. Saving Account 314 will be $9000. Portfolio management area 303 is the place for displaying the player's portfolio information. Because the player has no position yet, no position information shows here in the figure. The U-shaped area is the trading management area 302. The trade operation will mainly happen in this area. Because this is the start screen, the player will see a basic, simple screen. That is, to make the program start simple and less confusing, the system is designed intentionally to display nothing but the Next Open button 304 in this area. Upon the player clicking it, the simulation will start right away, as shown in FIG. 5.

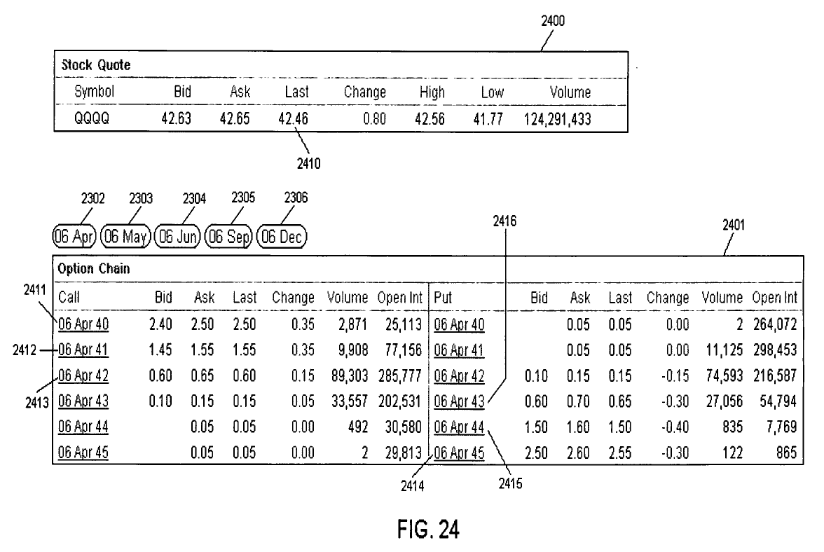

Dynamic daily chart 500 created by the system shows the NASDAQ composite index daily chart of May 12, 2004 at its open. Because the data is historically accurate, people saw it exactly the same as chart 500 when the market was open that day. There are two methods for trade operation. The player can either place orders or buy or sell at the open price immediately. For example, the player placed a PUT order cost $5000 as order1 513. Option trading is very complicated. The system of the present invention simplifies and unifies the trading processes of options and other complicated investment vehicles to allow the player to concentrate on developing the most important characters and skills of a successful investor. These will be discussed in detail later with reference to FIG. 23 and FIG. 24.

Now, the player is placing the second order, as illustrated in FIG. 5. Placing an option order in the simulation is simple. First, he needs to find a price level he wants to trade by dragging the Price Setting Triangle 311 of FIG. 3 to the price point and releasing the mouse button. A form with several radio boxes for selection will pop up, as illustrated by 1470 of FIG. 14. By checking the Open Order 1480 radio boxes and clicking the OK button 1490, the form will be closed. Now, order 514 is set around the previous low. Second, the player needs to decide whether he wants to buy or sell. Because the player had no positions yet, all sell selection items, including Sell Call 509 and Sell Put 511 are disabled by the system. So, only the buy selection items Buy Call 508 or Buy Put 510 are available. In our example, the player selected Buy Call 508. Then text field 512, combo field 507, buying power field 506 and Confirm button 505 show up. Next, the player needs to decide how much money to use for this order. He can select percentage of the buying power or enter the amount of the money. Taking this order as an example, where 100% is selected by the player, it means he wants to use all $5000 left for this order. Alternatively, he can enter a number, say $1000, into combo field 507. But more than $5000 is not allowed. Buying power 506 just gives the player an idea how much “real” money he can actually use. He can do nothing about this field. Once the amount of money is decided, the player can confirm the order by clicking Confirm button 505. The system will add another Price Setting Triangle at the place of Price Setting Triangle 311 of FIG. 3 so that the player can place more orders if needed. Now, the player can click All Day button 504 (this is the same button as the Next Open button 304 of FIG. 3, but with the caption changed) to advance the simulation. Before the player clicks All Day button 504, there is an optional text field 512 for the player to enter his reasons for placing this order. The system of the present invention has a Recording & Playback System 407, as depicted in FIG. 4. It is working quietly behind the scenes to record the player's trade operations, including the reasons for the orders. It gives the player opportunities to review his simulation records and help him quickly improving his skills.

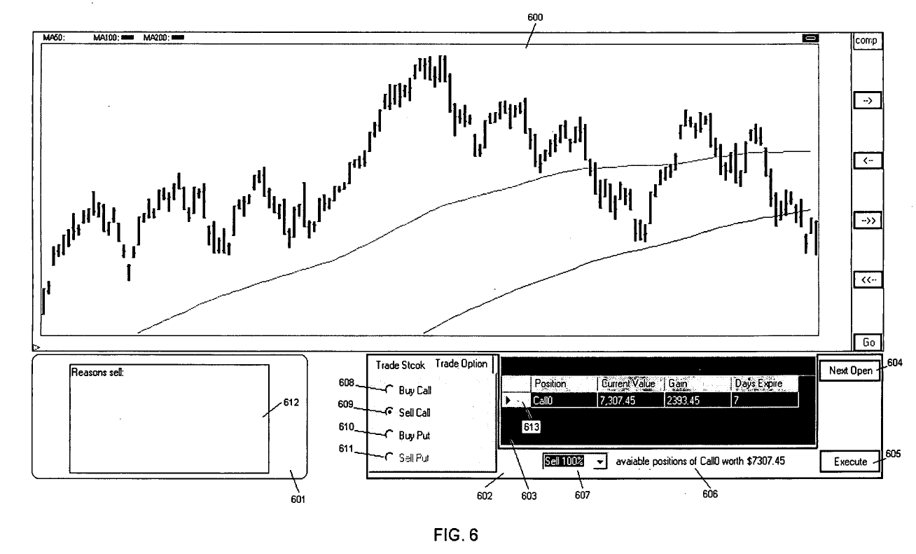

FIG. 6 is a player simulation screen shot when the market is about to be closed. It recreates the NASDAQ composite index daily chart of May 12, 2004 when the market was about to be closed. It is the continuation of the player trade operation shown in FIG. 5. Order1 513 was not executed and had expired, because the market price had never touched that potion during the day. Order 514 has been executed and the player enjoyed more than $2000 profits because the order was a Call and the market rose after it was executed. A row has been added into the portfolio area 603 to reflect the fact that the player has a position now.

There are 4 fields to describe a position. The first one is the name of the position; the second one is the current value of the position; the third one is the earning status of the position. A negative number means the position is losing money. Otherwise, it is earning money. The fourth one is days left before the option expires. This column can be used for other purposes like showing flashing Stop Loss warning. Now, the player still has chance to buy or sell positions at the closing price. If he decides to sell his position, he can simply check radio button Sell Call 609 and chose a position from portfolio area 603. Because the player has only one position at this time, he can simply click the row selector 613 to highlight the record. Then fields 612, 607, 606 and button 605 (this is the same button as the Confirm button 505, but with a changed caption) show up. To simplify and unify trade steps of different investment vehicles, the player can decide how much money to reclaim instead of how many shares or contracts to sell here. This option and operation will be discussed later in detail with reference to FIG. 23. Again, before selling the position, the player has an opportunity to list his reasons for the sell at text field 612. Execute button 605, if clicked enables the position selected to be sold at the close price immediately. If the player eventually decides not to sell his position and clicks the Next Open button 604, the simulation will goes on for another day.

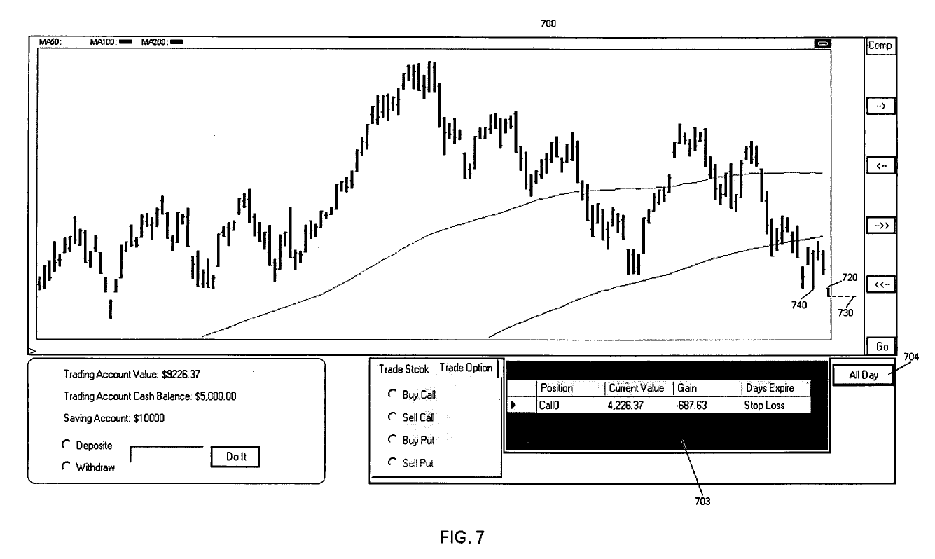

According to our example, unfortunately, two trading days later, the market did not go as the player expected. He was losing money and received a stop loss warning now. FIG. 7 has captured that moment.

FIG. 7 is a screen shot illustrating that the system of the present invention simulates a situation of stop loss. It should be noticed that, first the number in the Gain column of portfolio area 703 turns to negative; second, a Stop Loss warning sign flashes in the column of Days Expire field coupled with loud warning beep to remind the player that the stop loss threshold is reached. At this point, he needs to make a decision. He can take the warning by selling his losing position, or just simply ignore it. It should be emphasized that the bar 720 is not the same as the bar that would be seen at the close of that day. It is the bar that would be seen at the moment during the day when the stop loss threshold is reached. Like investors back on the particular day in history represented by the simulation, the player is facing the same situation. He does not know what will eventually happen that day. The market or investment might pull back and he might eventually make profits instead of losing, or it might get worse for him. He has to take the consequence for any decision he makes at that moment. The working mechanism of system is as following: The Portfolio Manager 409 of FIG. 4 is working behind the scenes at all times to check whether any opened order price has been hit, or any position threshold and any pre-set warning price have been reached. In this case, it detects that the stop loss threshold of the position is reached at some time of that day. It reports this to Simulation & Game Controller 402. 402 then directs the Dynamic Charts Generator 403 to create dynamic daily chart 700 of FIG. 7 and halt the simulation to give the player an opportunity to either sell his position at the stop price or just ignore it and resume the simulation. At the same time, the controller 402 requests the portfolio manager to update all records in the portfolio and set warnings only for the positions that have been hit. The Account Manager 408 is also requested by 402 to update the account accordingly.

Investors using technical analysis to make investment decisions usually read two kinds of investment charts. One is the daily chart, which uses bars to describe the market movement. Each bar represents the market movement of a day with open, close, high, and low. Another is intraday or multi-day intraday chart which uses bars or lines to describe the market movement minute by minute in great detail. The daily chart is used for predicting the longer trend of the market, while the intraday chart is used for predicting the market movement in a very short term. Many experienced investors find that combining the analysis of these two kinds of charts will turn out greater accuracy for timing the market.

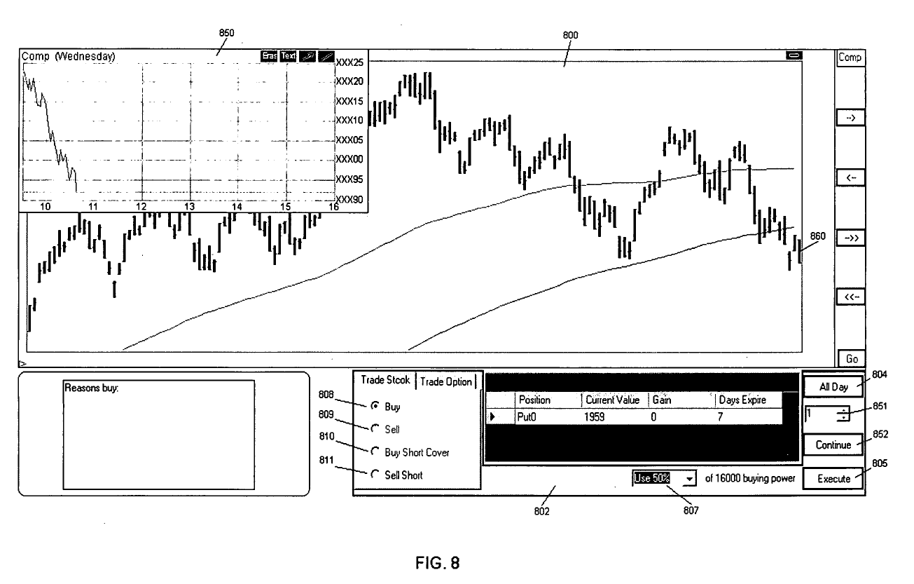

FIG. 8 is a screen shot of single stock simulation with daily investment chart and intraday investment chart. The obvious differences between the single investment simulation with daily investment chart and the one with daily and intraday investment charts are: 1) the one with intraday chart has an additional intraday chart 850 that simulates the market movement minute by minute; 2) it also has an intraday simulation speed controller 851 in the trade area 802. The player can speed up the intraday simulation by entering a bigger number to the controller 851 or a smaller number to slow it down. Number 1 means that with 1 second in real time, the intraday chart has already moved for 1 minute. On FIG. 8, the intraday market has 6 and half hours, so it will take 6.5 minutes to finish the intraday simulation for the 6.5 hours. If the number 6 is entered, that means with 1 second in real time the intraday chart has already moved 6 minutes, and so on so forth. Another difference is that there is also a Pause-Continue button 852 in the trading area 802 for the simulation with intraday chart. The player can click this button to pauses the intraday movement or resume the simulation. When the player clicks any enabled radio check box on the Trade Stock tab or on the Trade Option tab, the simulation will pause in order to give the player time to conduct his trade operations. The player can resume the simulation by clicking on this button. It should be emphasized that the daily chart 800 and the bar Today 860 will change accordingly as the intraday chart 850 is advancing toward the market close of the day.

Hedge is a sophisticated investment strategy. The idea behind this strategy is that because the market is hard to predict, when buying a big chunk of XYZ stock shares, investors minimize the investment risk by buying an XYZ. Put option with a small amount of money at the same time. FIG. 8 shows a player playing this strategy. The player has bought the Put option first, now he is buying the stocks. Trading stock in the system of the present invention uses the same steps as trading option. The player checks the Buy radio box 808 first, then decides how much money to use at combo box 807, then clicks Execute button 805 to finish this trade. The system of the present invention uses the same terminology as used in real trading markets. While non-traders might not be aware of these terms before using the system and software of the invention, they learn quickly. They will quickly understand that if they look at the charts and think the market is going up, they should select Call when trading options or Buy when trading stock. Alternatively, if they think the market is going down, select Put when trading options or Sell Short when trading stock, and so on so forth. The system was invented to simulate the real market.

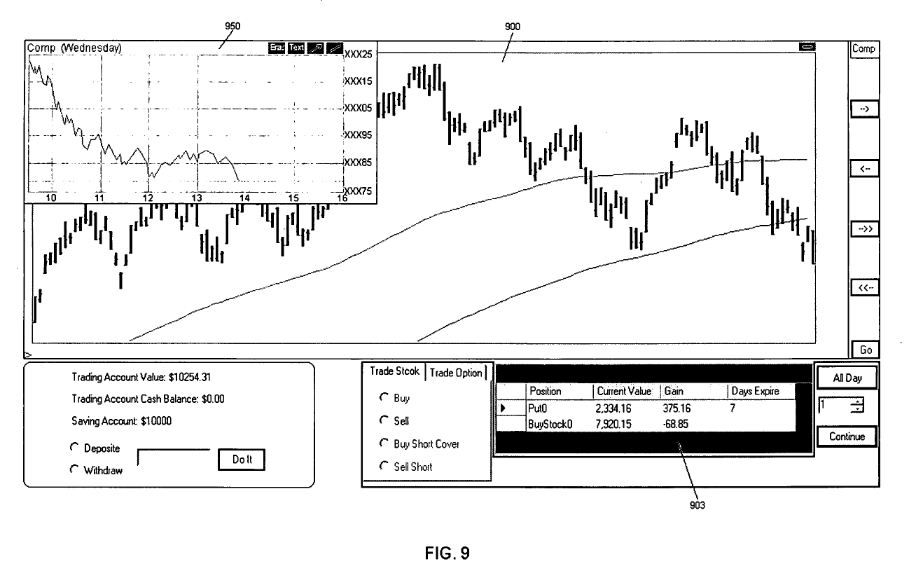

FIG. 9 demonstrates the ability of the system of the present invention to simulate many sophisticated investment strategies, including hedge. The intraday chart 950 shows a short term market trend downward. The player predicts the market wrong by buying $8000 in stocks. But, he bought $2000 Put at the same time by using the hedge strategy. It can be found from the portfolio area 903 that his stock position lost about $69 because of his wrong prediction; however, his Put position earned back about $375. So, the player actually makes about $254 net profits.

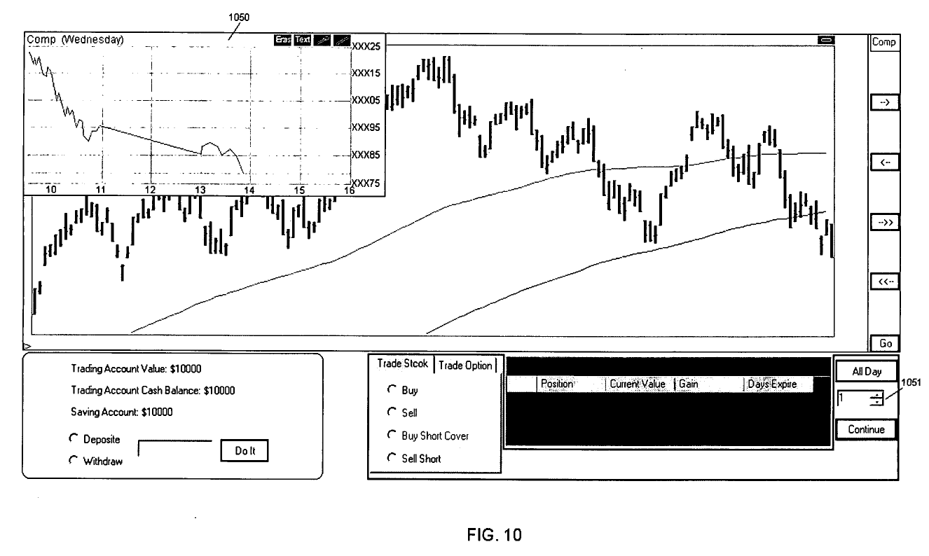

FIG. 10 demonstrates the ability of the system of the present invention to handle incomplete intraday data. If for any reason, the intraday historical data is not complete, the system can smoothly handle it, as though it were happening in the real market such as when a server is down or the internet connection is lost. Taking FIG. 10 as an example, the intraday data from 11 AM to 1 PM is missing. The charts seem frozen from 11 AM to 1 PM, but the system actually is still working. If the intraday speed controller 1051 is set at 1, that means the charts would keep frozen for about 120 seconds (since the system will advance 1 minute every second, 2 hours=120 minutes, that is 120 seconds) until it gets “new coming data” after 1 PM.

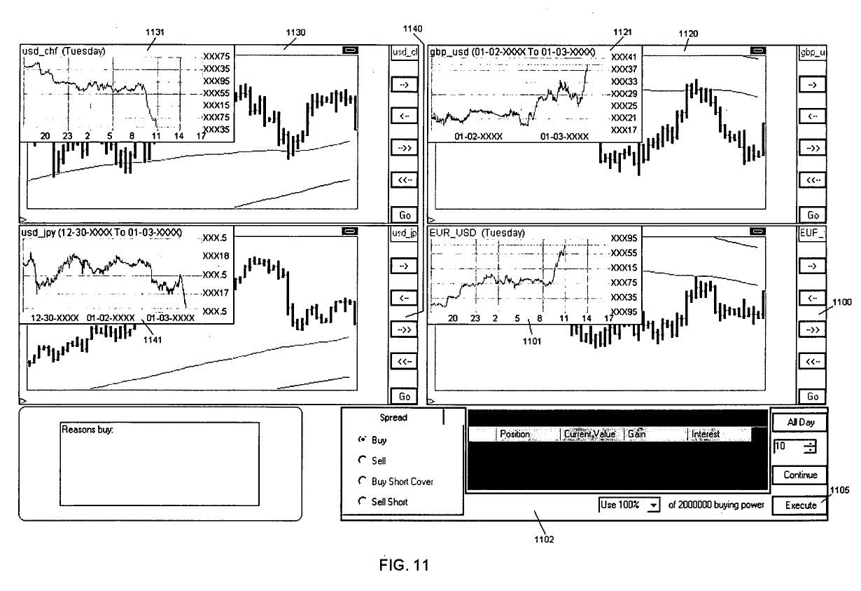

Experienced investors know that the markets are related. When the investor loses direction in one market, he might find a clue by analyzing another. Take the Dow Jones Industry Average Index (DJIA), the S & P 500 (SP500) index, and the NASDAQ index as an example. These 3 stock indexes are closely related. They are moving in the same direction most of the time. If the NASDAQ is found to be pretty strong, wise investors look at the DJIA and SP500 also. If they are not following the NASDAQ, investors should be cautious—the NASDAQ might fall back in the coming days. Likewise, when wondering whether a long lasting drop in the trend of the EUR_USD exchange rate has bottomed, investors may find a clue by looking at the USD_JPY exchange rate. FIG. 11 demonstrates the ability of the system of the present invention to synchronously simulate multiple markets at the same time. The daily chart 1100 and intraday chart 1101 are Euro vs. US dollar. The daily chart 1120 and 2-day intraday chart 1121 are British pound vs. US dollar. The daily chart 1130 and intraday chart 1131 are US dollar vs. Swiss frank, while daily chart 1140 and 3-day intraday chart 1141 are US dollar vs. Japanese Yen. It should be noticed that the intraday charts are different. The 1101 and 1131 are the intraday charts of Today, while 1121 and 1141 are the multi-day intraday chart. The player can set the days he wants to see on the intraday chart. The player can place orders for each of the simulated markets by using the Price Setting Triangle on each of the daily charts, or executing any order as it is done in the single stock simulation at any time. Again, it should be emphasized that the trading steps of foreign exchanges are same as trading stocks or options. The steps the player follows are: 1) select an investment vehicle which is skipped in this case because spread is the only investment vehicle in this simulation; 2) decide to buy or sell; 3) decide how much money to use for the trade; 4) click the Execute button 1105.

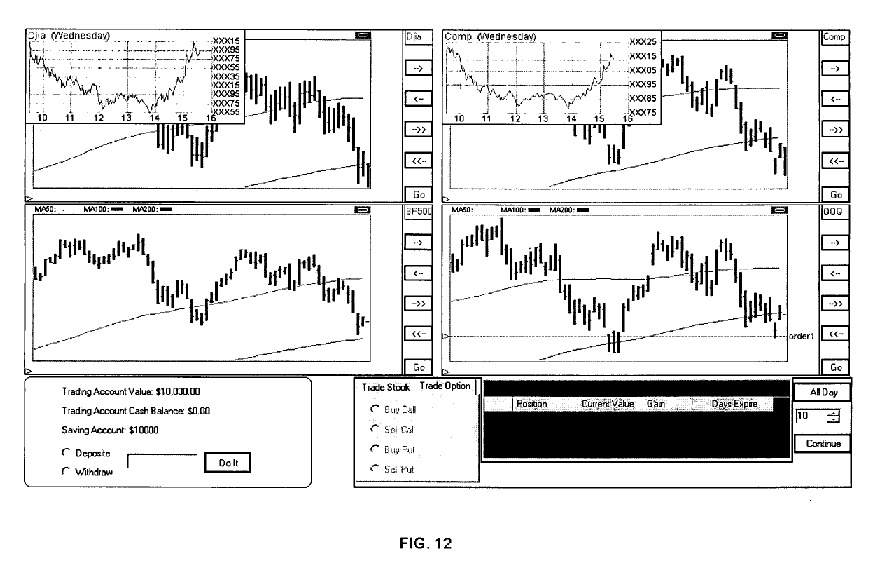

FIG. 12 demonstrates the capability of the system of the present invention to handle some complicated simulation situations. The player is simulating multiple indexes and stocks with intraday charts. However, the intraday charts need intraday data. Unfortunately, intraday data is available for COMP and DJIA while it is missing for QQQ and SP500. The system smoothly handles it by letting COMP and DJIA do the detailed intraday simulation while keeping QQQ and SP500 waiting until the markets close. Then every daily chart will be updated at the close to show the full chart of the day (the bar of Today will show completely with open, high, low and close). The player can place orders on any stocks and indexes at any time during the simulation. The orders placed on QQQ and SP500 will be checked at the close to determine whether the orders can be executed. If not, those orders will expire.

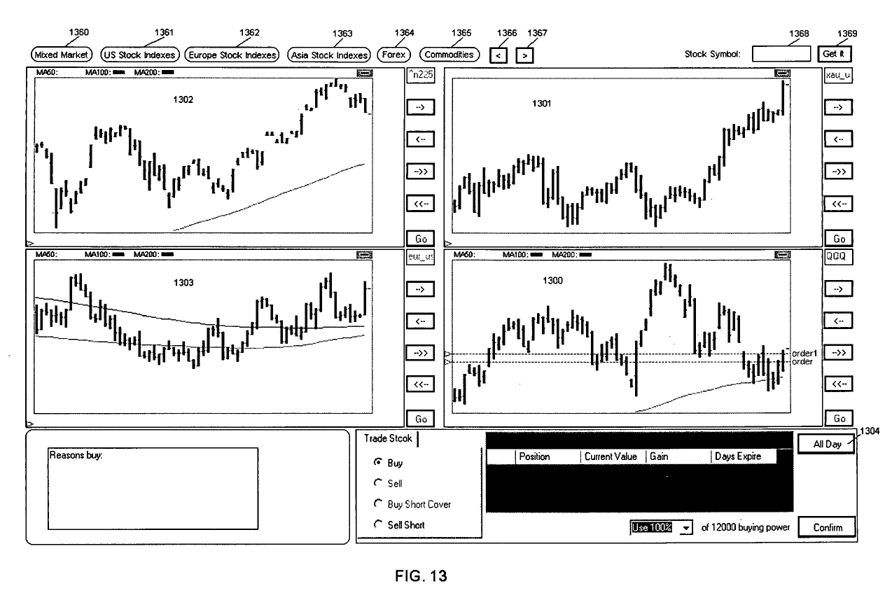

FIG. 13 demonstrates the ability of the system of the present invention synchronously to simulate unlimited investments and markets at the same time. With the help of modern technologies, especially the Internet, people all over the world are connected together. The markets separated by geographic location or country borders before are integrating into one global market now. The markets have an impact on each other. Studying the relationship of different markets and how they are related to each other has become more and more important. The system of the present invention provides just that ideal tool. The system uses real historical market data to bring a player back to any moment (as long as the historical data exists) in history to watch different market reaction to various news and events.

The system of the present invention allows unlimited investments and market simulation by grouping them into different screens of investments. Each screen has a screen number and screen name. It can hold several charts of investments. The player can see one screen at a time in the simulation. The system also provides a fast screen switching system to switch between screens quickly, and provides a searching system to quickly find out any screen of investments and present it to the player.

FIG. 13 is a screen shot of multi-markets all over the world at their open on Apr. 17, 2006. Daily chart 1300 shows an index QQQ of US market; daily chart 1301 demonstrates gold vs. US dollar market; daily chart 1302 is the Japanese Nikkei 225 index while daily chart 1303 is the euro vs. US dollar of foreign exchange market. The player is watching and simulating mixed markets. If the player clicks on US Stock Indexes button 1361, the charts on the screen will quickly switch to the US stock indexes like DJIA, SP500, and NASDAQ depending on how the player defined this screen before starting the simulation. It will be discussed how to define the multi-investment screens below with reference to FIG. 20. If the player clicks on the Asia Stock Indexes button 1363, the indexes of Asia markets will show up, and the player can do any trading operation on them. If the screen name of markets is not on current screen but it has been pre-defined, the player can use the shift button 1366 or 1367 to bring it out, or if the player knows any investment symbol on a screen, say XYZ, he can simply type XYZ into text field 1368 and click Get It button 1369 to locate it. The screen that has this symbol will display in its pre-defined layout.

FIG. 14 demonstrates how to set warnings, conditions, orders, and triggers in the system of present invention. The setting can be done in the daily chart of each investment. The player drags the Price Setting Triangle to a price level he desires and releases the mouse button. A small window like 1470, 1471, 1472 or 1473 will pop up. A warning can be set by checking the radio button Set Warning 1482 and then clicking the OK button 1492; a condition can be set by checking the radio button Set Condition 1483 and then clicking the OK button 1493; an order can be set by checking the radio button Open Order 1480 and clicking the OK button 1490 first, then the player can check either Buy 1408 or Sell Short 1411, and then select the money to use at 1407 and then click the Confirm button 1405. The set trigger is a little bit complicated. A trigger can be set by checking radio button Set Trigger 1481. Then the form 1471 will expand. A combo box 1494 for condition selection, a button 1495 for adding conditions and a text field 1496 for trigger conditions will show up. The player can select a condition or an operator like AND, OR from 1494 and click add button 1495. The system then adds the selected condition or operator and appropriate logic into the text field 1496. If the player knows programming logic, he can type the logic of the trigger conditions into the text field 1496 himself directly.

The system of the present invention provides a unique Record and Playback System to record the player trade operations during the simulation automatically. The player can review it after the simulation. This feature allows a player to quickly gain experience, develop his own strategies, learn lessons from mistakes, and identify his personal weakness resulting in losses and find ways to overcome them. A player can start reviewing historical records by clicking menu item History 103 of FIG. 1. A simulation historical file selection form 1500 will pop up as shown in FIG. 15. The player can select an investment symbol from the Main Symbol field 1501, and a player's name from Player Name field 1502. Once a player has been selected from 1502, all simulation files associated with the selected player will display on the simulation file list 1503. The player can select a simulation file from 1503. Review button 1504, if clicked, enables the player to start review simulation history file.

FIG. 16 is a screen shot of simulation records. This time, the daily chart 1600 shows all details of a chart: the bars, the dates and the historical prices. Normally, the system hides the dates and the historical prices from the player during the simulation, although the system can show them if needed. Experienced investors who use technical analysis to make their investment decisions know that investment is pretty much about gaining real market experiences, reading the charts and technical indicators, identifying the patterns, finding good trading strategies, having good money management, and discipline at all the time. It has little to do with prices and dates. In FIG. 16, the record table 1610 has ten columns. Column date shows trading dates; column Action shows trade actions the player took during the simulation. The actions can either be Buy or Sell; column Position Name shows the name of trade position; column Price displays trading prices during the simulation; column Ratio holds the ratio of money used or ratio of positions sold each time. This information is useful for developing a good trading strategy and good money management as well. Column Loss Money with Time gives the player an idea what Time Worth Money means in Options and Futures trading. Column Reasons Buy/Sell records the reasons for the player to make the investment decision. The player can also describe what is in his mind when making such decisions. These records are extremely valuable for helping the player to quickly learn lessons from the simulation, to identify his weaknesses, and to find a way to overcome them. By clicking on any record like record 1606 in the table 1600, the system will automatically show the bar 1607 on the daily chart 1600 for that day, which is 07-25-1996 in this case. A horizontal dash line 1605 will appear on the chart to indicate the price level of position Call2 bought by the player. The player can use shift buttons 1601, 1602, 1603 or 1604 to move the bars to left or right for studying. Zoom Out button 1608 is used to zoom out the chart. Once this button is clicked, more buttons will appear for zoom in and other purposes. These buttons will not be discussed here because their use and implementation are straightforward.

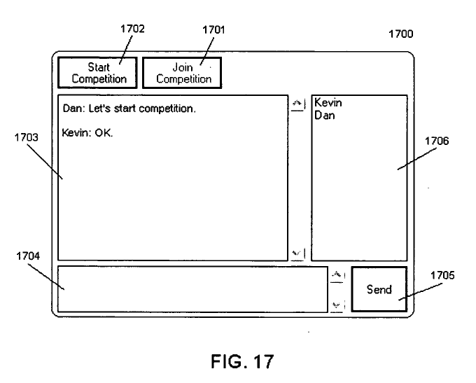

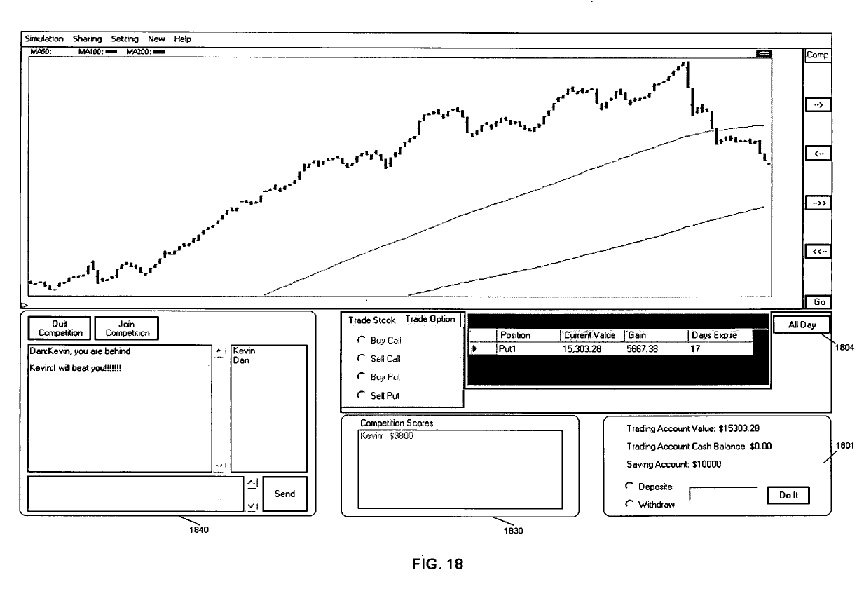

The system of the present invention is not just about real market simulation, but is also about a game. The player can play it alone or play it with other people all over the world through the Internet. FIG. 17 is a screen shot demonstrating that players all over the world can chat with each other through the system of the present invention. In the figure, two players are about to start an investment simulation competition game. Screen name list 1706 lists all player screen names in a chatting room; text field 1703 holds all chatting contents of this chatting room; text field 1704 is the place for the player to type his chatting contents; if button Send 1705 is clicked, contents in 1704 will be broadcasted to all players in this chatting room; button Join Competition 1701 allows a player to join a competition already started by other players; the Start Competition button 1702, if clicked enables a player starting a new competition, as illustrated by FIG. 18.

There are two types of investment simulation competitions. One is synchronous competition; another is asynchronous competition. For an asynchronous competition, the game starts on the same day for the initial players and ends on the same day for all participants based on their mutual agreement through online chatting. Each player can do the simulation at his own pace. For a synchronous competition, the game also starts on the same day for the initial players and ends on the same day for all participants based on their mutual agreement through online chatting. But the system also synchronizes each player's pace. If any player plays faster than others, the system will halt him from advancing to the next day until others finish the simulation of that day. It is desirable to discuss the working mechanism of the internet game system of the present invention before discussing FIG. 18.

Returning to FIG. 4, suppose there is User 0 who is using system 400. User 1 and User 2 are using the same system of the present invention as User 0. They meet through the internet with the help of Server 413. The P2P Module 401 is used for the players' systems to communicate. When the competition starts, each player's system has the same data, either from Local Database 412 or from Server 413. All players see the same screen interface. The charts are the same, starting Trade Account Value and Savings are the same. The default can be set at $10000 each. The player will interact with the system through Trade & Game Interface 404. The Simulation & Game Controller 402 can be considered the brain of the system. It will respond to requests from Data Loader 411, Trade Manager 410, Portfolio Manager 409, Trade & Game Interface 404, Account Manager 408, Recording & Playback System 407, and Coach System 406 and direct them to work together accordingly. Controller 402 will coordinate each sub-system working together, while directing P2P Module 401 to broadcast the current simulation status and the player's trade account value to others with the progress of the simulation. P2P Module 401 receives broadcasting from other player's systems and reports it to Simulation & Game Controller 402. 402 will direct other sub-systems to update the information and take actions in response to other player's status depending on the competition type chosen.

FIG. 18 is a screen shot of the internet competition game of the present invention. The competition screen looks almost the same as the investment simulation screen except: Account management area 1801 has been moved from the lower left corner to the lower right corner; and a chatting board 1840 is added to the lower left corner. It allows players to chat with each other during the competition game. Further, a competition scores board 1830 is added next to account management area 1801. It displays other player's scores. If the payer is playing faster than others, button 1804 will be disabled to prevent him from advancing to the next day during a synchronously competition. But the player can do other operations. Once all players in the game catch up, the system will automatically enable button 1804 to allow him to continue the game.

FIG. 19 is a screen shot of the Simulation Setting form. It is used to predefine the parameters and settings of a simulation. Combo box 1904 is used to select the main symbol. The main symbol is used as the key to identify a predefined simulation. When starting a simulation, the player can select a main symbol from the starting form 200 of FIG. 2. The system will use main symbol selected to find the simulation parameters and setting set here; text box 1905 is used to set the initial trade account value and cash balance; text box 1906 is used to set the initial saving account money; text box 1907 is used to set the fee that the broker would charge for a single trade; Area 1901 is the place for the simulation definition. Combo box 1910 is used to set intraday chart. If Yes is selected, an intraday chart will be added for minute by minute simulation besides the basic daily chart. If No is selected, the simulation will use only the daily chart. Area 1902 is for selecting trading vehicles ranging from Stock, Option, Future, Spread, and CFD (Contracts for Differences). If any new trading vehicle is invented, it can be easily added to the system for simulation using the same idea. Area 1903 is used to set the parameters of a specific trading vehicle, such as Stock, Option, or Future and so on so forth. Combo box 1908 is used for selecting simulation styles. There are two choices for the styles: one is Single Stock; another is Multi-Stocks. If Multi-Stocks is selected, button Def. Multi-Stocks 1909 would show up. Button 1909, if clicked would enable form 2000 to show up, as illustrated by FIG. 20.

The system of the present invention can simultaneously simulate unlimited investments, such as stocks, foreign exchanges, commodities, and any market for which price movement can be represented by investment charts. FIG. 20 is a screen shot of the setting screen of multi-investments simulation. The system of the present invention uses index number to decide the order of the switch buttons representing different screens. The index number can be entered into to Screen Index field 2006. Taking FIG. 13 as an example, the screen index number of Mixed Market 1360 is 0; the screen index number of US Stock Indexes 1361 is 1; and so on. After the screen index is chosen, a screen name can be entered into Screen Name field 2007. Area 2001 is the screen layout. It should be decided which investments should be on this screen and what the screen layout should be. The screen layout can be simply decided by entering investment symbols into the text fields 2002, 2003, 2004 and 2005. The investment daily charts will be displayed in the order as text fields 2002, 2003, 2004 and 2005 indicate. Once that is done, the player can click Save button 2008 to save the definition. If more investments need to be simulated, the above steps can be repeated to define more screens for those investments.

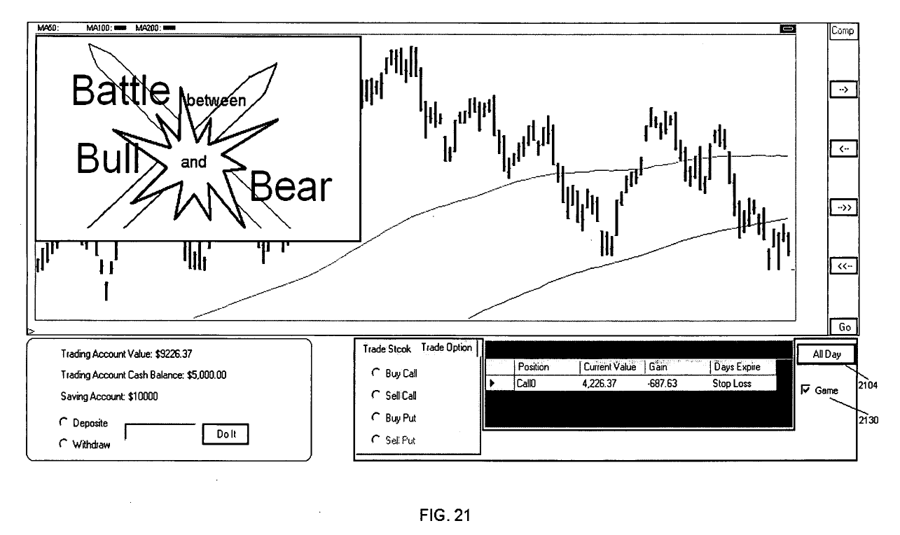

FIG. 21 demonstrates the 2-in-1 integration of video games, such as battle games, and the trade simulation training and game system of the present invention. The trade simulation can be done as usual except one thing. If the check box Game 2130 is checked, a battle game will launch after clicking button All Day 2104 if the player holds at least one position. In this embodiment, the player has a chance to join either the bulls to fight the bears if he held Calls or any long position, or join the bears to fight the bulls if he holds Puts or any short position. The player will eventually win the battle if his positions are gaining at the close of the day, no matter how bad his fighting skills are; other bulls or bears on his side can help him win the battle. The player would eventually lose the battle if his positions are losing at the close of the day, no matter how good his fighting skills are; other bulls or bears against his side will overpower him. But the battle will last longer if he is fighting hard and good. He will gain scores for his battle skills. The player will gain powers and meet more powerful opponents if he gains profits; otherwise, he will become weaker and meet less powerful figures. If he loses all of his money, he is dead. So, the simulation goes as usual, so does the battle game. The player can turn on/off the video game at any time by checking/un-checking the check box 2130. Investment education also will be embedded into the video game.

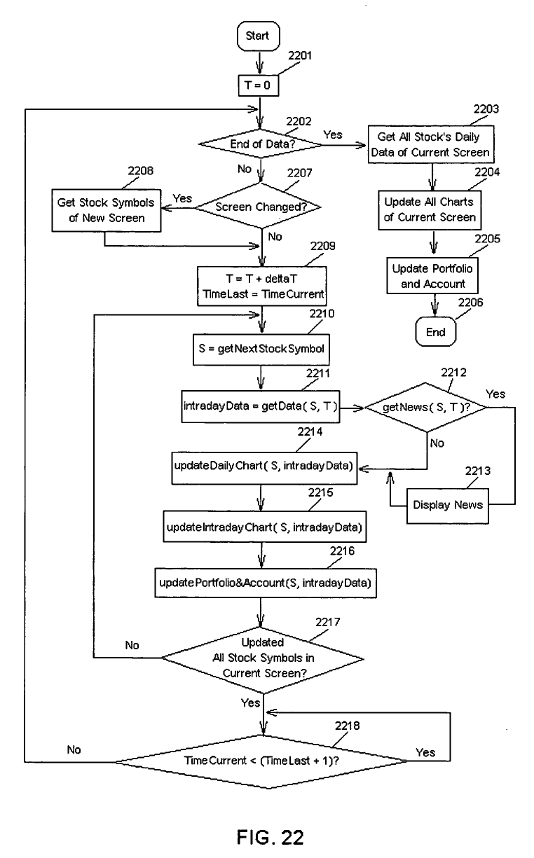

FIG. 22 is a flow chart illustrating the working mechanism of multi-investments simulation with multi-screens, intraday charts, and news broadcasting. Multi-investment simulation is very complicated. The first problem is that the data need to be unified. It is normal that some markets are open while other markets in the world are closed because of holidays or time zones. For example, the market data of Dec. 25 each year does not exist for most of the western countries, while it does exist for other countries. In order to solve this problem, two different mechanisms are implemented in the system of the present invention to ensure the smooth progress of the system. First, different investments and markets will have identical trading days each year. This is done by adding dummy data for the missing days into the true historical data for each of the investments. The price of open, high, low, and close for the missing days will be the same as its previous close price for those days. Second, the system also checks if the data for any day is missing for an investment, then it will draw a short flat line for the missing day at the place where the bar of Today should appear on the daily chart at the previous close price in the simulation. The intraday chart will not be shown and the player cannot trade on that day for this investment only. Investments without missing data on that day can be simulated and traded normally.

Another obstacle is demonstrated by step 2201. Starting time is set here. Starting time is a complicated issue when multi-markets are involved. The US stock market is open at 9:30 PM EST and closes at 4:00 PM EST, while the Chinese market is open at 9:30 PM EST and closes at 3:00 PM EST. If a currency market is involved, it becomes more complicated. The currency market is a 24/5 global market. It opens 24 hours a day and 5 days a week. It starts on Sunday 2 PM EST and closes on Friday 5 PM EST during a week. The system of the present invention unifies the simulation of different markets in two ways. First, it does so by dividing the continuous 24/5 markets, like the currency market into a discontinuous market. It regards 5 PM EST as the end of the current trading day and the start of next trading day. So the price at 5 PM EST of each day will be the close price of the day and open price of the next day. Of course, any time such as 12 PM EST can be used as the end of today and the start of next day if desired. Second, it does so by setting one day as a basic simulation session. When the simulation of a current trading day is over, the system will not automatically simulate the next day unless the player tells it to do so. In step 2201, if the simulation only involves stocks of the US stock market, the variable T will be set at 9:30 PM; however if multi-markets involved, taking FIG. 13 as an example, when clicking the Next Open 1304 (once Next Open button is clicked, the button's caption changes to All Day, as shown on FIG. 13), a new day begins. Because, in FIG. 13, eur_usd and xau_usd are 24/5 markets, they will open first. So the variable T actually is set to 5 PM of Today. When it is 7 PM of Today, the ̂225 (Nikkei 225 index of Japan) is open; QQQ will not start until 9:30 PM of the next day while ̂225 has been closed. The simulation will start the markets in the same sequence as in the real world. Step 2202 is checking whether it has reached the end of the day or the intraday data does not exist at all. Step 2202 returns true only if all of the investments in the simulation end for the day, or all of their intraday data don't exist at all. Otherwise, it returns false. If 2202 returns true, the next step is 2203. The system will read the daily data with open, high, low, and close and update the charts at step 2204 and portfolio and account at step 2205. Then it goes to the end 2206. If 2202 returns false, the next step is 2207. If the player switches the screen, for example from Mixed Market to US Stock Indexes in FIG. 13, step 2207 will return true. Then, the system will get those investment symbols defined in Simulation Setting as illustrated in FIG. 20. In step 2209, variable DeltaT is the time interval which is used to determine the speed of the intraday chart. Its default value is set to 1. Number 1 means that with 1 second in real time, the intraday chart has already moved 1 minute. The value of DeltaT can be changed at field 851 of FIG. 8. If the value of field 851 is set to 10, then T=T+10. Suppose the initial value of T is 5 PM, now the T is equal to 5:10 PM EST in this case. Step 2211 will use this time T to find the price data, news, and other things for investment S from 5 PM EST to 5:10 PM EST; then step 2212 will check whether there is any news about investment S from 5:00 PM EST to 5:10 PM EST. Step 2214 will use the intraday data from 2211 to redraw daily chart of investment S, which only reflects the market movement from 5:00 PM EST to 5:10 PM EST. Step 2215 will use the intraday data to redraw the intraday chart, which only displays the price curve from 5:00 PM to 5:10 PM. Step 2216 will update the portfolio and account if there is a position of investment S in the portfolio. Step 2217 will check whether all of the investment in the current screen have been updated. If not, it will go back to step 2210 to update the rest of the investments. Step 2218 will enforce the time interval. If the system gets the above jobs done early, it will hold here until 1 second has passed.

FIG. 23 is a diagram illustrating the working mechanism of the system of the present invention that simplifies and unifies the trading processes of all trading vehicles. The trading processes are simplified and unified to 1, 2, 3, and 4 steps. The Trade Manager 2300 (corresponding to Trade Manager 410 of FIG. 4) of the system of the present invention automatically handles all of the specific trading details of different vehicles for players. This approach frees the player from learning different complicated investment vehicles but still provides a simulation environment that is very close to the real market. This approach allows the player to focus on learning and developing the most important skills and characters that every successful investor must have. These skills and characters are: 1) Practical trading strategies that fit his personality; 2) Market experience; 3) Discipline; 4) Good money management. This approach makes the simulation so simple that anyone can use it and learn to use it in minutes. This approach makes it possible to integrate video games, like fighting games, seamlessly into the investment simulation system. This makes the already game-like system even more exciting and full of fun. Most importantly, by using this approach, the system of the present invention can simulate all markets for which movement can be described by investment charts, and can do it in a manner that is attractive, educational, and fun.

Before explaining the working mechanism of Trade Manager 2300, it is important to discuss the following assumptions adopted by the system of the present invention. First, the present invention uses infinite liquidity. It implies that there is an infinite market. When the player places a buy order, there are infinite shares/contracts opening to sell at the player's bid price; if the player places a sell order, there are infinite shares/contracts opening to buy at the player's ask price. In real market trading, bid price is the price a buyer would like to buy; ask price is the price a seller would like to sell. Because the simulation uses true historical data, which is the collection of the last price of an investment at a moment, the system will not necessarily use the last price to recreate the bid price and ask price at any moment. Instead, the bid price and ask price may be set by any method, based on any reason or combination of reasons. For example, the last price can be used as the bid price and ask price. Alternatively, the price may be set based on use of a mathematical formula that relies on any price for the investment during the day of interest, or any other value (e.g., average price for the day, average high or low of the day, etc.). Of course, it is easy to create the bid and ask price pair by using some mechanism and the last price or any other value, simply by applying a mathematical formula.

In real market trading, calculating the quantity of an investment is involved. If trading stock, how many shares to buy or sell should be considered; if trading options or futures, how many contracts to buy or sell needs to be calculated; and so on and so forth. However, it is difficult for many people, particularly children, to figure out how many shares of stock X he can buy with $10000 when X price is $11.25, for example. Besides, investment based on technical analysis is about reading charts and technical indicators. To achieve the best simulation training results, the system of the present invention normally hides the prices and dates from the player. If price is not available, the player has no way to calculate the quantity he can buy. The system of the present invention overcomes this obstacle by getting rid of quantity of a position. Instead, the value of a position is the only consideration. The idea is this: if the player bought a stock X with $10000, then the system knew that the player owns a position of stock X worth $10000 ($10000 is called the Initial_Value of the position). Although the player does not know the trading price, the system does, say $1 per share ($1 is called the Initial_Unit_Price of the position). Several days later, if the price rises to $1.2 per share ($1.2 is called the Current_Unit_Price of the position), the current value of the position can be calculated by the following formula:

Current_Value=Current_Unit_Price*Initial_Value/Initial_Unit_Price

When the player sells the position, he will be asked to give the percentage of the position to sell. If 20% (20% is called Sell_Ratio) is given, and the current value of the position is $12000, then the money reclaimed (called Money_Reclaim) can be calculated as follows:

Money_Reclaim=Sell_Ratio*Current_Value

In this case, $2400 cash will be claimed back. Then system needs to update the Initial_Value since 20% of the position has been sold. The new initial value will be calculated by the following formula:

New_Initial_Value=(1−Sell_Ratio)*Initial_Value

When selling the position, the player can enter the number of the money to be reclaimed instead of Sell_Ratio. If the current value of the position is $12000 and the money to be reclaimed is $2000, then Sell_Ratio can be calculated by the following formula:

Sell_Ratio=Money_Reclaim/Current_Value

### Then, Sell_Ratio can be used to get New_Initial_Value.

Now, it is quite clear, when placing an order, the Initial_Value and the Initial_Unit_Price of buying a position and Money_Reclaim and optionally the New_Initial_Value of selling a position are the only values the system needs to find out. These calculations are carried out by Trade Engine 2301.

If trading stock, Trade Engine 2301 chooses Stock Trade Engine 2320 to do it. When it is for buying a stock position, the data available are: 1. stock Initial_Unit_Price which comes from the historical data; and 2. total money used for the trade (called Total_Money) which has been chosen by the player. The Initial_Value for buying a stock position is calculated by the following formula:

Initial_Value=Total_Money−Broker_Fee

Broker_Fee is the fixed trading fee charged by a broker for each trade. It is set at text field 1907 of FIG. 19.

When it is for selling a stock position, the data available are: 1. the Initial_Value and Initial_Unit_Price which have been recorded when the position was bought; 2. The Current_Unit_Price which came from the historical data and. 3. The Sell_Ratio which is selected by the player. The Money_Reclaim for selling a stock position is calculated by the following formula:

Money_Reclaim=Sell_Ratio*(Current_Unit_Price*Initial_Value/Initial_Unit_Price)−Broker_Fee

If trading options, Trade Engine 2301 will chose Option Trade Engine 2321 to do it. Option trading is very complicated. FIG. 24 is a screen shot demonstrating an example for stock quote and option chain from the real market. Option Chain 2401 and Stock Quote 2400 are the places that the real world option traders obtain the quotes on option and equity prices. The option quote information updates in real time as the price of the underlined stock changes and new options are created. Different strike price has its corresponding option quote. For the same strike price, the quote changes for different months. So, the trader has many choices on selecting an option quote. There are many considerations for selecting an option quote. Different choices will have different results.

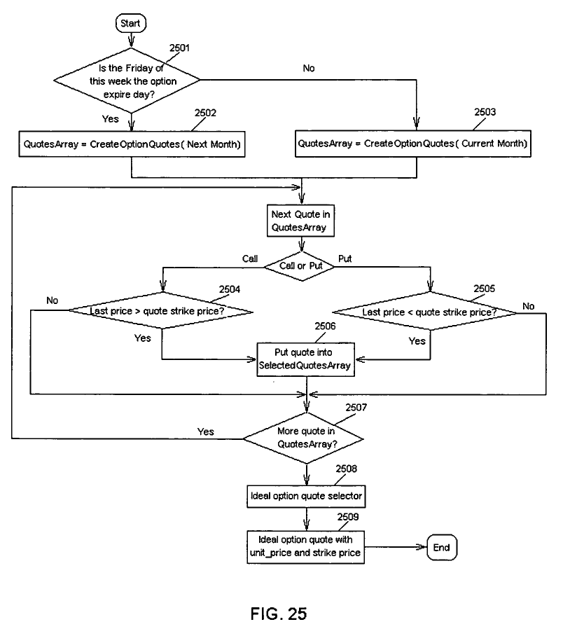

FIG. 25 is a flow chart illustrating how the system of the present invention selects an option quote. To make it simple, step 2501 illustrates that the system of the present invention will normally consider the option quotes of the current month. There is one exception, if it is already the last week when the option of the current month expires, the option quotes of the next month will be considered. Once the month is selected, the system will request the Option Pricing Generator to create the option quotes for the selected month and put the quotes into an array called QuotesArray. This is illustrated by step 2502 and step 2503. The working mechanism will be discussed shortly. Steps 2507, 2504, and 2505 illustrate that the system loops through the option quotes and only select those quotes that have hit the strike price. Taking the option quotes in FIG. 24 as an example, the equity's last price 2410 is $42.46. If buying a call, any quote with a strike price lower than $42.46 will be selected. In this case, selected option quotes will be 06 Apr 42 2413, 06 Apr 41 2412, and 06 Apr 40 2411. This is illustrated by step 2504 of FIG. 25. If buying a put, any quote with strike prices greater than $42.46 will be selected. They are 06 Apr 43 2416, 06 Apr 44 2415, and 06 Apr 45 2414. This is illustrated by step 2505 of FIG. 25. The quotes selected will be put into array SelectedQuotesArray as step 2506 illustrated. Finally, the system will loop through array SelectedQuotesArray and find the perfect quote. In the above example, if it is a call, the 06 Apr 42 2413 is too risky, 06 Apr 40 2411 is less risky, but the return is less at the same time. So, 06 Apr 41 2412 would be the perfect one. In contrast, if it is put, 06 Apr 44 2415 would be the perfect one for the same reasons. Once the perfect option quote is found, the Initial_Unit_Price is found. The Initial_Value can be calculated by the following formula:

Initial_Value=Total_Money−Broker_Fee−Option_Trading_Fee

Option_Trading_Fee is the fees the option buyer pays to the option writer (option seller). It varies from 0.5% to 2% of the total money used for the option trading. It can be set at area 1903 of FIG. 19 after checking check box Option from Trading Vehicles area 1902. When selling options, the Money_Reclaim can be calculated using the following formula:

Money_Reclaim=Sell_Ratio*(Current_Unit_Price*Initial_Value/Initial_Unit_Price)−Broker_Fee−Option_Trading_Fee

Note: Current_Unit_Price of option is not the last price of the equity. The Option Trade Engine 2321 can calculate it out by using the equity's last price and the strike price of Initial_Unit_Price.

Option Pricing Generator is used to generate the option quotes for a specific month. The Black-Scholes model is used to calculate the theoretical value of an option. The theoretical value will be used as the price of options. The Black-Scholes model considers the price of the stock, the option's strike price, the time remaining before expiration of the option, the volatility of the underlying stock, the stock's dividends, and the current interest rate. Although an option may be traded for more or less than its theoretical value, the market views the theoretical value as the objective standard of an option's value. The price of all options tends to migrate toward their theoretical value over time. Because the Black-Scholes model is well known, it will not be discussed here.

The Future Trade Engine 2322, Spread Trade Engine 2323, and CFD Trade Engine 2324 of FIG. 23 can be implemented in a similar way as the Stock Trade Engine 2320 or Option Trade Engine 2321. Suppose there were a new investment vehicle called X invented in the future. The system of the present invention still can simulate it by doing the following two steps: first, creating X Trade Engine 2325; second, plugging it into Trade Engine 2301. The system can be implemented in the same way as other trade engines described above. That is all that is needed to include the new investment vehicle into the present system. The system is thus adaptable and suitable for use with markets of all kinds, currently available and in the future.

It should be noted that: assuming a player will simulate only one investment vehicle trading, say stock trading only or option trading only, and assuming the player will always use 100% of his money or sell 100% of his positions, then the trade steps can be further simplified to 2 steps. 1) Decide buy or sell; 2) Confirm the trade. This is a special case of the simplified and unified trade steps of the present invention, and is encompassed by an embodiment of the invention.

It will be apparent to those skilled in the art that various modifications and variations can be made in the practice of the present invention without departing from the scope or spirit of the invention. Other embodiments of the invention will be apparent to those skilled in the art from consideration of the specification and drawings and in practice of the invention. It is intended that the specification and drawings be considered as exemplary only, with a true scope and spirit of the invention being indicated by the following claims.

1. An investment chart based interactive trade simulation training and game method, said simulation training and game method comprising the steps of:
using at least one computer;
using at least one database accessible by the computer, wherein the database comprises real historical information for a plurality of investments, and wherein the database optionally comprises simulation settings for the investments;
executing software on the computer that generates a simulation interface displayed on one or more screens, and wherein the simulation interface comprises one or more investment charts using the real historical data from the database; and
providing one or more users or players the ability to interact with the simulation interface and execute investment decisions within one or more simulated investment markets, wherein the investment markets are simulated based on the historical data.

2. The method of claim 1, wherein the computer is a personal computer, a video game device, a network server, or a hand-held computing or communication device.

3. The method of claim 1, further comprising:
providing only one key investment symbol representing settings of a simulation predefined in a Simulation Setting Method;
wherein the key investment symbol may be selected by a player.

4. The method of claim 1, further comprising:
providing a start date for the simulation, which may be selected by a player;
wherein the start date is: 1) randomly selected by the simulation and game system; 2) specified by the player; 3) specified in one or more files selected by the player; or 4) predefined in the simulation and game system.

5. The method of claim 1, further comprising:
providing a separate trading account and a saving account for the player, wherein funds may be transferred between the two accounts.

6. The method of claim 1, further comprising:
providing a charting method that optionally hides prices and dates on the investment chart(s) from the player during the simulation.

7. The method of claim 1, further comprising:
providing a Compressed Time Simulation Method, which allows for the simulation of investment(s) been conducted, but in a compressed manner with respect to time.

8. The method of claim 7, wherein the Compressed Time Simulation Method causes the simulated investment market to run at X minutes of historical market time per one second of real time, where X could be any number range from 1 to 1440.

9. The method of claim 1, further comprising:
providing a General Trading Method of Investments and a General Trading Method of Investment Vehicles, which allow a player to trade any investment through any investment vehicle in a unified and simplified manner.

10. The method of claim 9, wherein the General Trading Method of Investment Vehicles comprises the steps of:
optionally choosing a trading vehicle by a player;
choosing buy or sell of the selected trading vehicle for a trade by a player and further choosing a position to sell if sell is chosen and the player has more than one position;
optionally deciding a money amount used to buy or a money amount reclaimed for sell by the player;
optionally executing a buy or sell choice or confirming an order by a player;
wherein the method steps may be applied to any investment vehicle.

11. The method of claim 10, further comprising:
providing a Trade Engine to select an appropriate specific trade engine to handle the specific trading details of the selected trading vehicle;

12. The method of claim 10, wherein the General Trading Method of Investment Vehicles could be applied to a new investment vehicle that might be created in the future by creating a new trade engine for the new investment vehicle and plugging it into a Trade Engine of the simulation and game method.

13. The method of claim 10, wherein none, one, two or three of the optional steps are performed.

14. The method of claim 10, wherein the amount to buy or amount reclaim for sell is expressed as an amount of money, a percentage of money available, or a percentage of an available amount of a position.

15. The method of claim 1, further comprising:
providing a Visualized Setting Method for a player to set orders, warnings, conditions, and triggers directly on the investment charts.

16. The method of claim 1, further comprising:
providing an Auto-recoding and Playback Method to automatically record the player's trade operations during the simulation.

17. The method of claim 1, further comprising:
providing an Unlimited Investments Simulation Method to simulate multi-investments at the same time.

18. The method of claim 17, further comprising:
providing a synchronized simulation for all investments simulated.

19. The method of claim 1, further comprising:
providing a Missing Data Handling Method to smoothly handle many complicated situations resulting from missing data.

20. The method of claim 1, further comprising a single investment simulation with daily investment chart method that uses limited historical data of an investment to simulate the market of that investment;
wherein the limited historical data is a set of daily historical data and the daily historical data comprises the price of open, close, high, low and optionally the volume of one trading day.

21. The method of claim 1, further comprising a single investment simulation with daily investment chart and intraday investment chart method that uses detailed historical data of an investment to simulate the market of that investment;
wherein the detailed historical data is a set of daily historical data and a set of intraday data.

22. The method of claim 1, further comprising a multi-investments simulation with daily investment chart method that uses limited historical data of the investments to simulate the markets of those investments;
wherein the limited historical data is a sets of daily historical data and the daily historical data comprises the price of open, close, high, low and optionally the volume of one trading days.

23. The method of claim 1, further comprising a multi-investments simulation with daily investment chart and intraday investment chart method that uses detailed historical data of the investments to simulate the markets of those investments;
wherein the detailed historical data is a set of daily historical data and a set of intraday data of those investments.

24. The method of claim 1, further comprising an on-line investment simulation competition method, wherein the on-line investment simulation competition method comprises the steps of:
providing an investment simulation that simulates one or more investments for which trading can occur with at least one investment chart;
providing an online chatting method to allow a player to chat with other players all over the world;
allowing a player to start a competition or join a started competition; and
providing a score board to dynamically display the changing money other players earned throughout the competition.

25. The method of claim 24, wherein the method is a synchronous online investment simulation competition by using a Synchronous Competition Method.

26. The method of claim 24, wherein the method is an asynchronous online investment simulation competition by using an Asynchronous Competition Method.

27. The method of claim 1, further comprising a 2-in-1 investment simulation and video game method, wherein the 2-in-1 investment simulation and video game method comprises the steps of:
providing an investment simulation that simulates one or more investment markets for which trading can occur with at least one investment chart; and
providing a video game in which players win or lose based on their performance in the investment simulation.

28. An investment chart based interactive trade simulation training and game system, said system comprising:
one or more computers;
one or more databases accessible by the compute(s); wherein the databases have real historical information for a plurality of investments, and wherein the databases optionally comprise simulation settings for the investments;
an optional internet connection that enables the system to work on-line and a player to communicate with other people all over the world;
software executing on the computer(s) to generate a simulation interface displayed on one or more screens, and wherein the simulation interface comprises one or more investment charts using the real historical data from the database; and
wherein the system permits one or more users or players to interact with the simulation interface and execute investment decisions within one or more simulated investment markets, wherein the investment markets are simulated based on the historical data.

29. The system of claim 28, wherein the computer is a personal computer, video game device, network server, or hand-held computing or communication device.

30. The system of claim 28, wherein the system simulates investments in a compressed manner with respect to time.

31. The system of claim 28, wherein the system simulates investments in a compressed manner with respect to time which causes the simulated investment markets to run at X minutes of historical market time per one second of real time, where X can be any number ranging from 1 to 1440.

32. The system of claim 28, wherein the system simulates investments with a start date, wherein the start date is: 1) randomly selected by the system; 2) specified by a player; 3) specified in a file selected by the player; or 4) predefined in the system.

33. The system of claim 28, wherein the system displays investment data in a form of one or more investment charts on one or more display screens, wherein the system optionally conceals prices and dates on the investment charts from the player during the simulation.

34. The system of claim 28, further comprising a Simulation Setting System; wherein the Simulation Setting System collects the following information:
a main symbol for the simulation to be defined;
a simulation mode for the simulation to be defined;
screen definitions if multi-investments simulation is involved, which are provided with the help of a Multi-screens Definition System;
settings for different investment vehicles if multi-investment vehicles are involved in the simulation; and
parameters for trading.

35. The system of claim 34, wherein the Multi-screens Definition System defines one or more screens by collecting the following information:
a screen ID number for each screen to be defined;
a screen name for each screen to be defined;
investment symbols and their layout on the screen for each screen to be defined; and
optionally collecting the above information for each screen to define more screens.

36. The system of claim 28, wherein the software comprises instructions for:
providing a separate trading account and a saving account for the player, wherein funds may be transferred between the two accounts.

37. The system of claim 28, wherein the system further comprises a General Trading System of Investments and a General Trading System of Investment Vehicles, which allow a player to trade any investment through any investment vehicle in a unified and simplified manner.

38. The system of claim 37, wherein the General Trading System of Investment and General Trading System of Investment Vehicles allows a player to trade any investment through any investment vehicle by the following steps:
optionally choosing a trading vehicle;
choosing buy or sell of the selected trading vehicle for a trade by a player and further choosing a position to sell if sell is chosen and the player has more than one position;
optionally deciding a money amount used to buy or a money amount reclaimed for sell;
optionally executing a buy or sell choice or confirming an order;
wherein none, one, two or three of the optional steps are performed.

39. The system of claim 38, wherein the amount to buy or amount reclaim for sell is expressed as an amount of money, a percentage of money available, or a percent of an available amount of a position.

40. The system of claim 37, wherein the General Trading System of Investment Vehicles has a Trade Engine to select an appropriate specific trade engine to handle the specific trading details of the selected trading vehicle.

41. The system of claim 37, wherein the General Trading System of Investment Vehicles is applied to a new investment vehicle that might be created in the future by creating a new trade engine for the new investment vehicle and plugging it into a Trade Engine of said General Trading System of Investment Vehicles.

42. The system of claim 28, further comprising a Visualized Setting System;
wherein the Visualized Setting System 1) provides graphic cues on the investment chart; 2) allows a player to move the graphic cues to a appropriate price level on the investment chart to set price desired; and 3) allows the player to set warnings, open orders, set conditions, and set triggers after a desired price has been set.

43. The system of claim 28, further comprising an Auto-recoding and Playback System to automatically record a player's trade operations during the simulation.

44. The system of claim 28, further comprising an Unlimited Investments Simulation System to help the multi-investments simulation.

45. The system of claim 44, wherein the Unlimited Investments Simulation System provides a synchronized simulation for all investments been simulated.

46. The system of claim 28, further comprising a Missing Data Handling System to smoothly handle many complicated situations relating to missing data.

47. The system of claim 28, further comprising a single investment simulation with daily investment chart system.

48. The system of claim 28, further comprising a single investment simulation with daily investment chart and intraday investment chart system.

49. The system of claim 28, further comprising a multi-investments simulation with daily investment chart system.

50. The system of claim 28, further comprising a multi-investments simulation with daily investment chart and intraday investment chart system.

51. The system of claim 28, further comprising an on-line investment simulation competition system, wherein the on-line investment simulation competition system comprises:
providing an investment simulation system that simulates one or more investments for which trading can occur with at least one investment chart;
providing an online chatting system to allow a player to chat with other players all over the world;
allowing a player to start a competition or join a started competition; and
providing a score board to dynamically display the changing money other players earned throughout the competition.

52. The system of claim 51, wherein the system is a synchronous on-line investment simulation competition system.

53. The system of claim 51, wherein the system is an asynchronous on-line investment simulation competition system.

54. The method of claim 28, further comprising a 2-in-1 investment simulation and video game system, wherein the 2-in-1 investment simulation and video game system comprises:
providing an investment simulation system that simulates one or more investment markets for which trading can occur with at least one investment chart; and
providing a video game system in which players win or lose based on their performance in the investment simulation.

55. A storage medium comprising a computer program, wherein the computer program is capable of running on a computer and comprises instructions for:
simulating at least one market in which trading can occur using historical data and other information from that market; and
displaying the data and information to a user in a form comprising at least one investment chart.

56. The storage medium of claim 55, which is a portable storage medium, an optical compact disk, an optical digital virtual disk, a hard drive, or random access memory.
